(19) United States
(12) Patent Application Publication
(10) Pub. No.: US 2025/0158867 A1
(43) Pub. Date: May 15, 2025

(54) TECHNIQUES FOR IN-BAND CLIPPING WITH NOISE REPETITION AND SHAPING

(71) Applicant: QUALCOMM Incorporated, San Diego, CA (US)

(72) Inventors: Kianoush HOSSEINI, San Diego, CA (US); Jing JIANG, San Diego, CA (US); Peter GAAL, San Diego, CA (US); Tao LUO, San Diego, CA (US); Igor GUTMAN, Hod HaSharon (IL)

(21) Appl. No.: 18/510,484

(22) Filed: Nov. 15, 2023

(51) Int. Cl. H04L 27/26

(52) U.S. Cl. CPC H04L 27/2623

(57) ABSTRACT

Methods, systems, and devices for wireless communication are described. A wireless communication device may receive control signaling that indicates a change in one or more radio frequency thresholds for wireless signaling. The wireless communication device may perform, as part of an in-band clipping procedure, noise repetition and noise shaping to reduce a peak-to-average power ratio (PAPR) associated with the wireless signaling. The noise repetition and the noise shaping may include generating a set of values with one or more first values and one or more second values. The one or more first values may be associated with an error margin between a sample of a wireless communication signal and a clipping threshold. The one or more second values may be inversions of the one or more first values. The wireless communication device may apply the set of values to the wireless communication signal to reduce PAPR.

### FIELD OF TECHNOLOGY

The present disclosure relates to wireless communication, including techniques for in-band clipping (IBC) with noise repetition and shaping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include wireless communication devices that perform communications in accordance with one or more radio frequency (RF) thresholds. The wireless communication devices may utilize peak-to-average power ratio (PAPR) reduction techniques to satisfy the one or more RF thresholds.

### SUMMARY

The described techniques relate to improved methods, systems, devices, and apparatuses that support techniques for in-band clipping (IBC) with noise repetition and shaping. For example, the described techniques may enable a wireless communication device to receive control signaling that indicates a change in one or more radio frequency thresholds for wireless signaling. Based on the change in radio frequency thresholds, the wireless device may perform (e.g., as part of an IBC procedure) noise repetition and noise shaping to reduce a peak-to-average power ratio (PAPR) associated with the wireless signaling. In some examples, the wireless device may generate (e.g., compute, identify, determine) a set of values including one or more first values and one or more second values. The one or more first values may be associated with an error margin between a sample of a wireless communication signal and a clipping threshold (e.g., clipping noise). The one or more second values may be inversions of the one or more first values (e.g., may be inverted copies of each respective first value). The wireless communication device may apply a scalar (e.g., may shape) the set of values and may apply the set of values to the wireless communication signal to reduce PAPR.

A method for wireless communication by a wireless communication device is described. The method may include receiving control signaling that indicates a change in one or more radio frequency (RF) thresholds for wireless signaling by the wireless communication device and performing, during an IBC procedure, noise repetition and noise shaping to reduce a PAPR associated with the wireless signaling, where one or more parameters associated with the noise repetition and the noise shaping are based on the change in the one or more RF thresholds.

A wireless communication device for wireless communication is described. The wireless communication device may include one or more memories storing processor executable code, and one or more processors coupled with the one or more memories. The one or more processors may individually or collectively operable to execute the code to cause the wireless communication device to receive control signaling that indicates a change in one or more RF thresholds for wireless signaling by the wireless communication device and perform, during an IBC procedure, noise repetition and noise shaping to reduce a PAPR associated with the wireless signaling, where one or more parameters associated with the noise repetition and the noise shaping are based on the change in the one or more RF thresholds.

Another wireless communication device for wireless communication is described. The wireless communication device may include means for receiving control signaling that indicates a change in one or more RF thresholds for wireless signaling by the wireless communication device and means for performing, during an IBC procedure, noise repetition and noise shaping to reduce a PAPR associated with the wireless signaling, where one or more parameters associated with the noise repetition and the noise shaping are based on the change in the one or more RF thresholds.

A non-transitory computer-readable medium storing code for wireless communication is described. The code may include instructions executable by one or more processors to receive control signaling that indicates a change in one or more RF thresholds for wireless signaling by the wireless communication device and perform, during an IBC procedure, noise repetition and noise shaping to reduce a PAPR associated with the wireless signaling, where one or more parameters associated with the noise repetition and the noise shaping are based on the change in the one or more RF thresholds.

Some examples of the method, wireless communication devices, and non-transitory computer-readable medium described herein may further include operations, features, means, or instructions for receiving second control signaling that indicates a set of resources allocated for noise in accordance with the noise repetition and the noise shaping.

In some examples of the method, wireless communication devices, and non-transitory computer-readable medium described herein, the set of resources includes resources allocated for an uplink control channel.

Some examples of the method, wireless communication devices, and non-transitory computer-readable medium described herein may further include operations, features, means, or instructions for transmitting the wireless signaling via a channel, where one or more resources from among the set of resources may be dropped based on the one or more resources being external to the channel in a frequency domain.

In some examples of the method, wireless communication devices, and non-transitory computer-readable medium described herein, receiving the control signaling may include operations, features, means, or instructions for receive the control signaling indicating the change in the one or more RF thresholds based on at least a channel type, or a modulation order, or a modulation and coding scheme (MCS), or a resource allocation size, or a resource allocation location, or a transmission rank, or a waveform type, or a frequency band, or a combination thereof associated with the wireless signaling.

In some examples of the method, wireless communication devices, and non-transitory computer-readable medium described herein, receiving the control signaling may include operations, features, means, or instructions for receiving, via the control signaling, information indicating an amount by which at least one of the one or more RF thresholds may be to change.

In some examples of the method, wireless communication devices, and non-transitory computer-readable medium described herein, receiving the control signaling may include operations, features, means, or instructions for receiving, via the control signaling, an indication that at least one of the one or more RF thresholds may be not to be satisfied by the wireless communication device.

In some examples of the method, wireless communication devices, and non-transitory computer-readable medium described herein, performing the noise repetition and the noise shaping may include operations, features, means, or instructions for sampling a wireless communication signal in accordance with a sampling rate, comparing a set of multiple samples to a clipping threshold, where the set of multiple samples may be obtained in accordance with the sampling, generating, based on the comparing, a set of values including one or more first values and one or more second values, where each first value of the one or more first values may be associated with an error margin between a respective sample of the set of multiple samples and the clipping threshold and each second value of the one or more second values includes an inversion of a respective first value, and applying the set of values to the set of multiple samples prior to an interpolation of the wireless communication signal.

Some examples of the method, wireless communication devices, and non-transitory computer-readable medium described herein may further include operations, features, means, or instructions for applying a scalar to the set of values, where applying the set of values to the set of multiple samples may be based on applying the scalar.

Some examples of the method, wireless communication devices, and non-transitory computer-readable medium described herein may further include operations, features, means, or instructions for modifying the set of values by applying a parameter to each value of the set of values, where applying the set of values to the set of multiple samples may be based on modifying the set of values in accordance with the parameter.

Some examples of the method, wireless communication devices, and non-transitory computer-readable medium described herein may further include operations, features, means, or instructions for generating a second set of values including the one or more first values and one or more null values, modifying the second set of values by applying a second parameter to each value of the second set of values, and combining the modified set of values with the modified second set of values in accordance with a combination function, where applying the set of values may be based on the combining.

In some examples of the method, wireless communication devices, and non-transitory computer-readable medium described herein, modifying the set of values may include operations, features, means, or instructions for applying a respective value of the parameter to each value of the set of values, where the respective value of the parameter may be based on a resource block (RB) associated with a respective value of the set of values to which the parameter may be being applied.

Some examples of the method, wireless communication devices, and non-transitory computer-readable medium described herein may further include operations, features, means, or instructions for performing, prior to the comparing, a first transformation of the set of multiple samples from a time domain to a frequency domain, where the first transformation may be performed in accordance with the sampling rate, the sampling rate less than an upsampled sampling rate.

Some examples of the method, wireless communication devices, and non-transitory computer-readable medium described herein may further include operations, features, means, or instructions for applying a first phase ramp function to the set of multiple samples after the first transformation and performing a second transformation of the set of multiple samples from the frequency domain to the time domain, where each sample of the set of multiple samples may be shifted in the time domain based on applying the first phase ramp function, and where comparing the set of multiple samples to the clipping threshold may be based on the second transformation.

Some examples of the method, wireless communication devices, and non-transitory computer-readable medium described herein may further include operations, features, means, or instructions for applying a first phase ramp function to the set of multiple samples in a frequency domain, where the first phase ramp function does not shift the set of multiple samples in a time domain, generating a first set of error values based on applying the first phase ramp function, applying a second phase ramp function to the set of multiple samples after applying the first phase ramp function, where each sample of the set of multiple samples may be shifted in the time domain based on applying the second phase ramp function, and generate a second set of error values based on generating the first set of error values and applying the second phase ramp function, where the set of values may be further based on at least the first set of error values, or the second set of error values, or the one or more first values, or a combination thereof.

A method for wireless communication by a wireless communication device is described. The method may include sampling a wireless communication signal in accordance with a sampling rate, comparing a set of multiple samples to a clipping threshold, where the set of multiple samples are obtained in accordance with the sampling, generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value, and applying the set of values to the set of multiple samples prior to an interpolation of the wireless communication signal.

A wireless communication device for wireless communication is described. The wireless communication device may include one or more memories storing processor executable code, and one or more processors coupled with the one or more memories. The one or more processors may individually or collectively operable to execute the code to cause the wireless communication device to sample a wireless communication signal in accordance with a sampling rate, compare a set of multiple samples to a clipping threshold, where the set of multiple samples are obtained in accordance with the sampling, generate, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value, and apply the set of values to the set of multiple samples prior to an interpolation of the wireless communication signal.

Another wireless communication device for wireless communication is described. The wireless communication device may include means for sampling a wireless communication signal in accordance with a sampling rate, means for comparing a set of multiple samples to a clipping threshold, where the set of multiple samples are obtained in accordance with the sampling, means for generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value, and means for applying the set of values to the set of multiple samples prior to an interpolation of the wireless communication signal.

A non-transitory computer-readable medium storing code for wireless communication is described. The code may include instructions executable by one or more processors to sample a wireless communication signal in accordance with a sampling rate, compare a set of multiple samples to a clipping threshold, where the set of multiple samples are obtained in accordance with the sampling, generate, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value, and apply the set of values to the set of multiple samples prior to an interpolation of the wireless communication signal.

Some examples of the method, wireless communication devices, and non-transitory computer-readable medium described herein may further include operations, features, means, or instructions for applying a scalar to the set of values, where applying the set of values to the set of multiple samples may be based on applying the scalar.

Some examples of the method, wireless communication devices, and non-transitory computer-readable medium described herein may further include operations, features, means, or instructions for modifying the set of values by applying a parameter to each value of the set of values, where applying the set of values to the set of multiple samples may be based on modifying the set of values in accordance with the parameter.

Some examples of the method, wireless communication devices, and non-transitory computer-readable medium described herein may further include operations, features, means, or instructions for generating a second set of values including the one or more first values and one or more null values, modifying the second set of values by applying a second parameter to each value of the second set of values, and combining the modified set of values with the modified second set of values in accordance with a combination function, where applying the set of values may be based on the combining.

In some examples of the method, wireless communication devices, and non-transitory computer-readable medium described herein, modifying the set of values may include operations, features, means, or instructions for applying a respective value of the parameter to each value of the set of values, where the respective value of the parameter may be based on an RB associated with a respective value of the set of values to which the parameter may be being applied.

Some examples of the method, wireless communication devices, and non-transitory computer-readable medium described herein may further include operations, features, means, or instructions for performing, prior to the comparing, a first transformation of the set of multiple samples from a time domain to a frequency domain, where the first transformation may be performed in accordance with the sampling rate, the sampling rate less than an upsampled sampling rate.

Some examples of the method, wireless communication devices, and non-transitory computer-readable medium described herein may further include operations, features, means, or instructions for applying a first phase ramp function to the set of multiple samples after the first transformation and performing a second transformation of the set of multiple samples from the frequency domain to the time domain, where each sample of the set of multiple samples may be shifted in the time domain based on applying the first phase ramp function, and where comparing the set of multiple samples to the clipping threshold may be based on the second transformation.

Some examples of the method, wireless communication devices, and non-transitory computer-readable medium described herein may further include operations, features, means, or instructions for applying a first phase ramp function to the set of multiple samples in a frequency domain, where the first phase ramp function does not shift the set of multiple samples in a time domain, generating a first set of error values based on applying the first phase ramp function, applying a second phase ramp function to the set of multiple samples after applying the first phase ramp function, where each sample of the set of multiple samples may be shifted in the time domain based on applying the second phase ramp function, and generate a second set of error values based on generating the first set of error values and applying the second phase ramp function, where the set of values may be further based on at least the first set of error values, or the second set of error values, or the one or more first values, or a combination thereof.

### BRIEF DESCRIPTION OF THE DRAWINGS

FIG. 1 shows an example of a wireless communications system that supports techniques for in-band clipping (IBC) with noise repetition and shaping in accordance with one or more aspects of the present disclosure.

FIG. 2 shows an example of a wireless communications system that supports techniques for IBC with noise repetition and shaping in accordance with one or more aspects of the present disclosure.

FIG. 3 shows an example of a flow diagram that supports techniques for IBC with noise repetition and shaping in accordance with one or more aspects of the present disclosure.

FIG. 4 shows an example of a flow diagram that supports techniques for IBC with noise repetition and shaping in accordance with one or more aspects of the present disclosure.

FIG. 5 shows an example of a flow diagram that supports techniques for IBC with noise repetition and shaping in accordance with one or more aspects of the present disclosure.

FIG. 6 shows an example of a process flow that supports techniques for IBC with noise repetition and shaping in accordance with one or more aspects of the present disclosure.

FIGS. 7 and 8 show block diagrams of devices that support techniques for IBC with noise repetition and shaping in accordance with one or more aspects of the present disclosure.

FIG. 9 shows a block diagram of a communications manager that supports techniques for IBC with noise repetition and shaping in accordance with one or more aspects of the present disclosure.

FIG. 10 shows a diagram of a system including a device that supports techniques for IBC with noise repetition and shaping in accordance with one or more aspects of the present disclosure.

FIGS. 11 through 16 show flowcharts illustrating methods that support techniques for IBC with noise repetition and shaping in accordance with one or more aspects of the present disclosure.

### DETAILED DESCRIPTION

Some wireless communication devices may utilize schemes (e.g., crest factor reduction (CFR) schemes) to reduce peak-to-average power ratio (PAPR) to increase signal transmission efficiency and improve overall signal quality. For example, a wireless device (e.g., a user equipment (UE), a network entity, or some other wireless communication device) may use in-band clipping (IBC) techniques, which may use a relatively low sampling rate, may have a relatively low complexity, and may reduce power emissions into neighboring frequency resources. However, IBC, when applied to wireless communication signals, may be associated with a margin between expected radio frequency (RF) performance metrics and actual RF performance metrics for the wireless communication signal (e.g., RF thresholds such as in-band emission (IBE), adjacent channel leakage ratio (ACLR), spectrum emissions mask (SEM), other RF thresholds, or any combination thereof). That is, IBC may, in some examples, result in a wireless device exceeding a performance expectation associated with one or more RF thresholds. Additionally, or alternatively, IBC may reduce frequency emissions but may result in an increased error vector magnitude (EVM) metric, which may degrade wireless signal quality. Moreover, some conditions may allow one or more RF thresholds to be reduced (e.g., relaxed) such that PAPR may be further reduced by utilizing relatively aggressive PAPR reduction schemes. Thus, techniques to control a performance tradeoff associated with IBC (e.g., a tradeoff between frequency emissions and EVM), as well as signaling mechanisms that enable wireless devices to communicate changes in the one or more RF thresholds and may be beneficial.

Various aspects of the present disclosure generally relate to signaling mechanisms to coordinate changes to one or more RF thresholds and one or more techniques for improved PAPR reduction schemes. In some examples, a wireless communication device (e.g., a UE, a network entity) may utilize control signaling and noise repetition and noise shaping techniques in combination with IBC to control a performance tradeoff (e.g., a tradeoff between one or more RF thresholds). For example, the control signaling may indicate a change in one or more RF thresholds, and the wireless device may perform IBC with noise repetition and noise shaping based on the changed RF thresholds indicated via the control signaling.

In some examples, the noise repetition and the noise shaping (e.g., in combination with IBC) may enable the wireless device to generate a set of values (e.g., a vector of noise values) that includes one or more first values and one or more second values. Each first value may represent an error margin between a respective sample of a wireless signal and a clipping threshold associated with IBC (e.g., clipping noise). Each second value may be an inverted duplicate of a respective first value (e.g., noise repetition, inverted repetitions of the clipping noise). In some examples, the wireless device may apply a scalar value to the set of values (e.g., noise shaping, to shape the set of values). In some examples, to control a performance tradeoff between RF thresholds, the wireless device may modify the set of values by one or more parameters, a function (e.g., a linear combination or some other function), or both based on the changes to the one or more RF thresholds. The wireless device may apply the set of values to the wireless signal (e.g., to the samples of the wireless signal), which may reduce PAPR in accordance with a performance tradeoff. Accordingly, a wireless communication device may account for changes in one or more RF thresholds and control an associated performance tradeoff, which may improve PAPR reduction schemes, increase coverage, improve utilization of communication resources, and improve power efficiency of wireless communication signals, among other benefits.

Aspects of the disclosure are initially described in the context of wireless communications systems. Aspects of the disclosure are further illustrated by and described with reference to flow diagrams, process flows, apparatus diagrams, system diagrams, and flowcharts that relate to techniques for IBC with noise repetition and shaping.

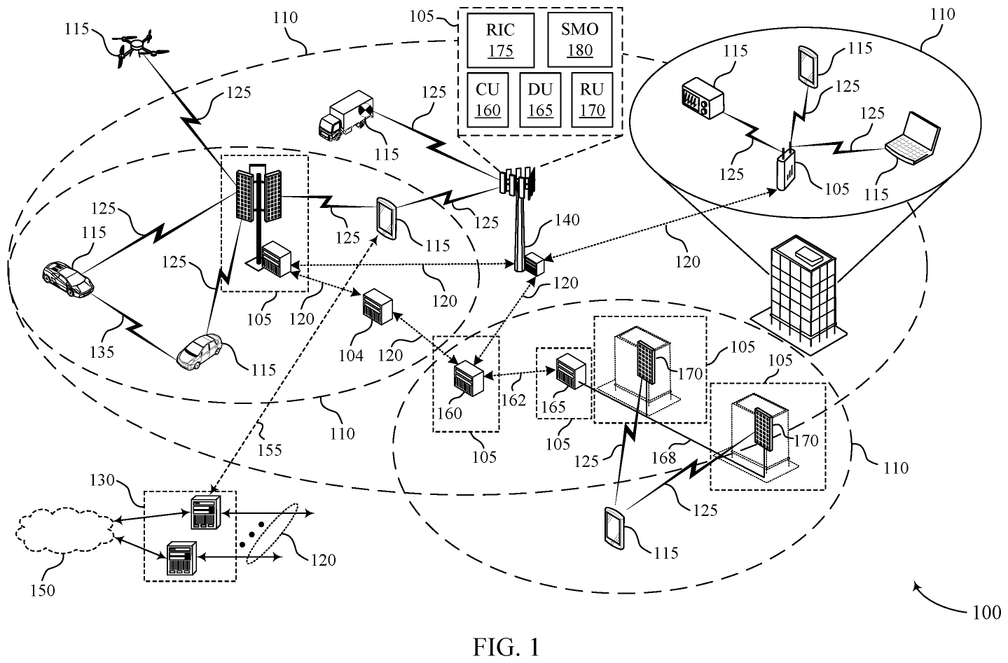

FIG. 1 shows an example of a wireless communications system 100 that supports techniques for IBC with noise repetition and shaping in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for IBC with noise repetition and shaping as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a wireless device (e.g., a UE 115, a network entity 105, or some other wireless device herein) may use IBC techniques to reduce PAPR in wireless communication signals. However, IBC may cause the wireless device to exceed performance expectations associated with some RF thresholds (e.g., IBE) but not with other RF thresholds (e.g., EVM). Moreover, some expectations for RF thresholds may be changed (e.g., reduced, removed, increased) in accordance with network conditions (e.g., based on coordination across network entities 105). In accordance with techniques herein, and to improve PAPR reduction schemes, a UE 115 and a network entity 105 (e.g., or other wireless communication device) may exchange signaling to indicate changes to one or more RF thresholds, and may perform IBC with noise repetition and shaping techniques based on the signaling. For example, a UE 115 may control a performance tradeoff between one or more RF thresholds to optimize PAPR based on the changes to the RF thresholds.

In some examples, noise repetition and the noise shaping may include generating a set of values (e.g., an error vector, noise vector) that includes error values and inverted duplicates of the error values. In some examples, the wireless device may further modify the set of values using one or more parameters or a function to control a performance tradeoff between the RF thresholds. The parameters and the function may be based on the changes to the RF thresholds. The wireless device may apply the set of values to the wireless signal, which may optimize PAPR reduction with respect to the one or more RF thresholds, thereby improving PAPR reduction schemes, increasing coverage, and improving power efficiency of wireless communication signals, among other benefits.

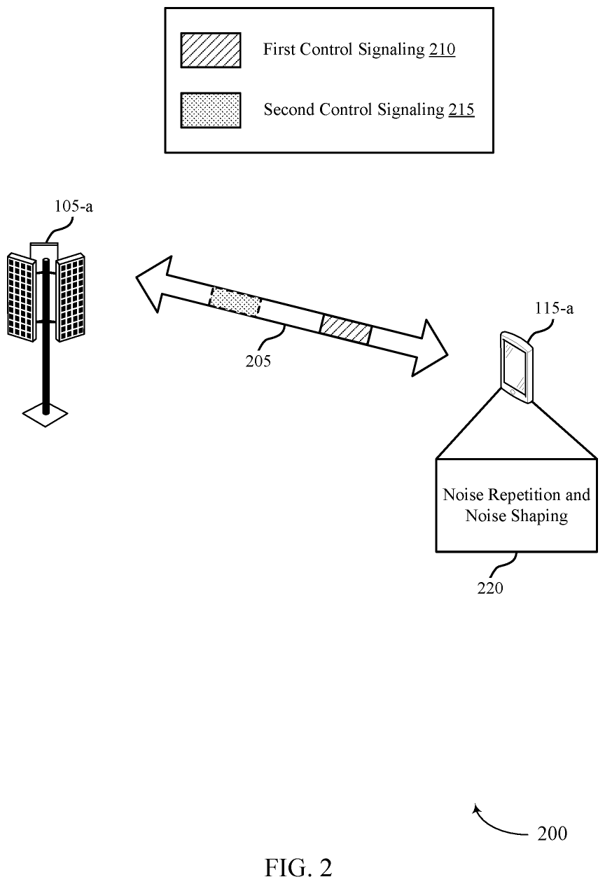

FIG. 2 shows an example of a wireless communications system 200 that supports techniques for IBC with noise repetition and shaping in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of, or include, a network entity 105 and UE 115 described with reference to FIG. 1. Although a network entity 105-a and a UE 115-a are shown, the techniques herein may be applied by one or more other devices described herein, including with reference to FIG. 1. The network entity 105-a may communicate (e.g., control signals, data signals, or other signals) with the UE 115-a using a communication link 205. In some examples, the network entity 105-a and the UE 115-a may exchange first control signaling 210 and second control signaling 215 via the communication link 205, and the UE 115 (e.g., and/or the network entity 105-a) may perform noise repetition and noise shaping procedure 220 (e.g., during an IBC procedure) as described herein to improve PAPR reduction schemes.

In some examples, wireless communication devices in the wireless communications system 200 (e.g., the UE 115-a, the network entity 105-a) may perform techniques to reduce PAPR. Some PAPR reduction techniques may include clipping samples of a wireless signal (e.g., discrete-time samples of a continuous-time signal), which may limit an amplitude for each sample of a wireless signal to be within a threshold value. In some cases, PAPR may vary based on sample points of a wireless signal waveform (e.g., discrete Fourier transform-spread-orthogonal frequency division multiplexing (DFT-s-OFDM) waveform in time-domain). For example, samples obtained at a relatively low sampling rate (e.g., a Nyquist sampling rate) may be associated with relatively low PAPR (e.g., PAPR may the same as modulation at integer Nyquist sample points), while samples obtained according to a relatively high sampling rate (e.g., higher than a Nyquist sampling rate, oversampling, upsampling) may produce samples with relatively high PAPR (e.g., PAPR may be close to Gaussian distribution at some offset from Nyquist sample points, samples at midpoints between peaks of the wireless signal). Accordingly, clipping may be performed on an upsampled (e.g., oversampled) waveform to improve PAPR reduction. However, upsampling or oversampling a wireless signal may be associated with relatively high power consumption, among other adverse effects.

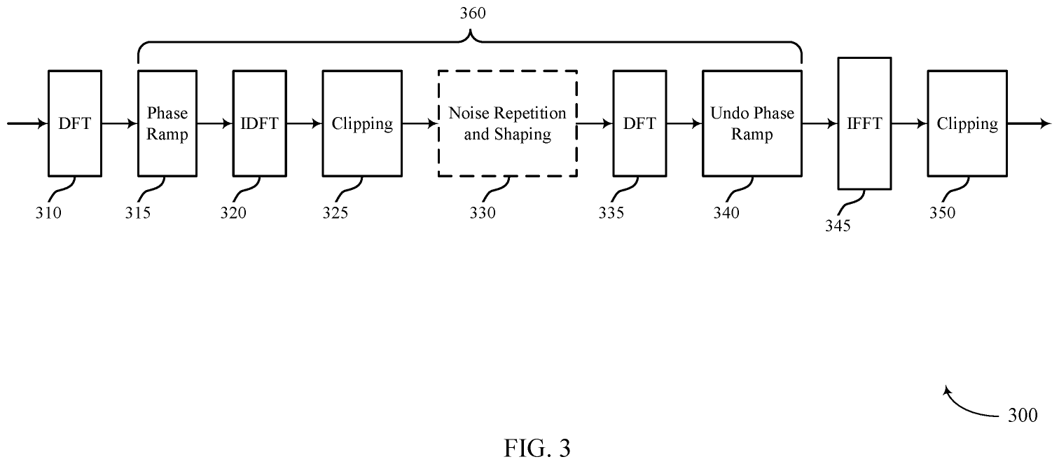

In some cases, clipping samples of a wireless signal may be performed in accordance with an IBC scheme, which may be described in further detail with reference to FIG. 3. IBC techniques may include clipping high PAPR samples without upsampling the wireless signal. For instance, IBC may be performed on one or more symbols of a wireless signal (e.g., modulated symbols) after one or more transformations of the wireless signal (e.g., clipping may be performed over M time-domain samples after an M-point discrete Fourier transform (DFT)) but prior to a transformation of the wireless signal into the time-domain for transmission (e.g., prior to an N-point inverse fast Fourier transform (IFFT). In some cases, IBC may retain noise associated with the clipping (e.g., clipping noise) inside a resource allocation (e.g., may be equivalent to perturbing modulation symbols) and may not create emission (e.g., leakage into other frequency resources), which may result in improved spectrum confinement and PAPR reduction. However, while IBC may not generate additional emission, IBC may be associated with a relatively high EVM. That is, IBC may not balance (e.g., optimize) a performance tradeoff between one or more RF thresholds for a wireless device.

Additionally, a wireless device (e.g., a transmitting device, the network entity 105-a, the UE 115-a) of the wireless communications system 200 may be expected to satisfy (e.g., meet) one or more RF thresholds (e.g., RF performance metrics such as IBE, ACLR, SEM, EVM). IBC may enable the wireless device to satisfy the one or more RF thresholds. However, in some cases, the one or more RF thresholds may change (e.g., some RF requirements may be relaxed) based on some conditions of the wireless communications system 200 (e.g., based on an agreement between the network entity 105-a and the UE 115-a, based on an agreement across gNBs, or the like). Thus, based on changes to the RF thresholds, a wireless device may further reduce PAPR by controlling a performance tradeoff associated with the IBC scheme. However, some signaling mechanisms may not support indication of changes to RF thresholds, and IBC may not support a mechanism to control a performance tradeoff associated with the RF thresholds.

In accordance with techniques described herein, the network entity 105-a may transmit first control signaling 210 to the UE 115-a that indicates a change in one or more RF thresholds for wireless signaling. The network entity 105-a may additionally, or alternatively, transmit second control signaling 215 to the UE 115-a that indicates a set of resources allocated for noise in accordance with a noise repetition and the noise shaping procedure 220 (e.g., indicates which resources to use for noise repetition and shaping). The UE 115-a (e.g., or the network entity 105-a) may perform the noise repetition and the noise shaping procedure 220 (e.g., as described in greater detail with reference to FIGS. 3-6) based on the first control signaling 210 (e.g., based on the change in the one or more RF thresholds), the second control signaling 215, or both.

In some examples, the first control signaling 210 may indicate that the UE 115-a may reduce one or more RF thresholds (e.g., when additional bandwidth is used for noise repetition and shaping). That is, RF performance expectations may be reduced, and the UE 115-a may be indicated whether it can relax some of the RF thresholds (e.g., RF requirements). For example, an RF threshold may be reduced (e.g., IBE may be relaxed) if the network entity 105-a does not schedule adjacent RBs for other devices, or if adjacent RBs are used but granted with low modulation order or low coding rate and can tolerate additional noise. As another example, ACLR can be relaxed based on coordination across multiple network entities 105 (e.g., between the network entity 105-a and other network entities 105). In some examples, performing the noise repetition and the noise shaping procedure 220 in accordance with the first control signaling 210 may further reduce PAPR. For example, if an IBE RF threshold (e.g., IBE requirement) is reduced (e.g., lifted), IBC in combination with the noise repetition and the noise shaping procedure 220 (e.g., and additional hard-clipping) may further reduce PAPR as compared the case where the IBE RF threshold is not reduced (e.g., where the IBE is enforced for an allocation of size 135 RBs with starting RB of 69).

In some examples, the information of the first control signaling 210 and the second control signaling 215 may be dynamically communicated via the communication link 205. For example, the first control signaling 210, the second control signaling 215, or both may represent examples of downlink control information (DCI), radio resource control signaling (RRC), a medium access control-control element (MAC-CE), some other type of control signaling, or any combination thereof. In some examples, the network entity 105-a may transmit a single control message that indicates the changes in RF thresholds and the set of resources allocated for noise, or the network entity 105-a may transmit multiple separate control messages. Additionally, or alternatively, the same information may be based on or indicated via a predefined set of rules. That is, the UE 115-a may identify the change in RF thresholds and the set resources for the noise repetition and noise shaping procedure 220 based on a set of rules (e.g., instead of, or in combination with, receiving the first control signaling 210 and the second control signaling 215). For example, the UE 115-a (e.g., and the network entity 105-a) may be configured with a set of resources for noise shaping and noise repetition (e.g., for accommodating the clipping noise, for the noise repetition and noise shaping procedure 220).

Depending on an allocation for the set of resources, the set of resources may be placed on different locations. For example, if a quantity of RBs at a left edge of the allocation (e.g., left side of bandwidth) are allocated, the same quantity of RBs may be allocated on the right edge of the allocation. The set of resources may be at a bandwidth edge (e.g., from the network perspective), where the resources may be partially used for control signaling (e.g., physical uplink control channel (PUCCH) signaling, physical downlink control channel (PDCCH) signaling). Control signaling resources may have a relatively higher reliability as compared with other resources allocate for other types of signaling, such that an addition of noise in such control signaling resources may be negligible.

In another example, if the allocation is toward a bandwidth center, the resources for noise clipping may be placed on a first side of the allocation, a second side of the allocation, or split across the two sides (e.g., the split may be uniform or of different lengths between the two sides). In some examples, if a quantity of RBs allocated for the noise is larger than half of a total quantity of RBs in a channel, the noise may be placed on a first side of the allocation, a second side of the allocation, or both, and the resources (e.g., virtual resources) that are outside of (e.g., external to) the channel may be dropped (e.g., only the portion of RBs residing within the channel bandwidth may remain).

In some examples, the first control signaling 210, the second control signaling 215, or both may be based on a channel type, a modulation order, a modulation and coding scheme (MCS), a resource allocation size, a resource allocation location, a transmission rank, a waveform type, a frequency band, or any combination thereof. For example, if a PUCCH signal and a physical uplink shared channel (PUSCH) signal are simultaneously transmitted, the UE 115-a may use PUCCH resources for the noise repetition and noise shaping procedure 220. As another example, if device supports multiple users (e.g., a customer premise equipment (CPE)), the noise repetition and noise shaping procedure 220 may be performed over resource elements (REs) allocated for a relatively lower modulation order. As another example, when PDCCH signals and physical downlink shared channel (PDSCH) signals are multiplexed (e.g., via frequency division multiplexing (FDM)), the set of resources for the noise repetition and noise shaping procedure 220 may be allocated on the resources used for PDCCH.

In some examples, the first control signaling 210 (e.g., or the set of preconfigured rules) may indicate an amount by which a RF threshold is to change (e.g., may set a limit on how much each RF requirement can be relaxed). For example, the first control signaling 210 may indicate that an RF threshold (e.g., EVM) may be proportionally reduced (e.g., relaxed by a percentage value, when a receiver has a capability to perform data protection on demand (DPoD)). In another example, the first control signaling 210 may indicate an amount to reduce the RF threshold (e.g., an IBE mask may be lifted by a decibel (dB) value). In another example, the first control signaling 210 may indicate that at least one of RF threshold may not to be expected to be satisfied (e.g., by the UE 115-a). For example, some RF thresholds (e.g., ACLR or SEM) may be removed (e.g., may be lifted or may have no limit).

The described techniques may thereby provide for the network entity 105-a to transmit control signaling to the UE 115-a (e.g., and one or more other wireless devices) to dynamically or semi-statically indicate a change in one or more RF thresholds for communications by the UE 115-a, a quantity of resources allocated for noise, or both based on one or more channel conditions or other conditions associated with the wireless communications system 200. The UE 115-a may utilize the indicated information to perform relatively efficient and reliable noise repetition and noise shaping procedure 220, as described in further detail elsewhere herein, including with reference to FIGS. 3-6.

FIG. 3 shows an example of a flow diagram 300 that supports techniques for IBC with noise repetition and shaping in accordance with one or more aspects of the present disclosure. For example, the flow diagram 300 may support techniques for IBC with noise repetition and noise shaping. The operations of the flow diagram 300 may be performed by a network entity 105, a UE 115, or some other transmitting wireless device herein (e.g., as described with reference to FIGS. 1 and 2) to reduce PAPR associated with a wireless communication signal. The flow diagram 300 may include multiple processing blocks including processing blocks 360, which may be associated with an IBC procedure. Although the flow diagram 300 includes single arrows between blocks, it is to be understood that each block may simultaneously perform operations for multiple inputs (e.g., multiple samples at a time).

Some PAPR reduction techniques (e.g., some CFR schemes not including IBC) may be associated with operating at a relatively high baseband sampling rate (e.g., oversampling), may be allocation bandwidth independent (e.g., same for 1-RB or 100-RB allocations), may be waveform agnostic (e.g., same algorithm for both DFT-s-OFDM and cyclic prefix-OFDM (CP-OFDM)), or any combination thereof. In some cases, such PAPR reduction techniques may result in noise (e.g., CFR noise) that may impact an entire spectrum (e.g., emissions associated with ACLR, SEM, and IBE may be a bottleneck on how much the PAPR can be reduced). However, a wireless communication device (e.g., a UE 115, a network entity 105) as described herein may apply IBC techniques (e.g., the processing blocks 360) for PAPR reduction which may operate at relatively low sampling rate, may be allocation bandwidth dependent (e.g., may be easier to implement for smaller bandwidth allocations), may be waveform specific (e.g., may utilize intrinsic properties of DFT-s-OFDM waveform for lower complexity, but may also apply to CP-OFDM), and may provide one or more mechanisms to balance between one or more RF thresholds (e.g., between PAPR, EVM, and emission).

For example, IBC techniques may contain frequency emissions within an allocation (e.g., clipping noise may be kept fully inside the allocation) when applied to a waveform (e.g., a wireless communication signal). In some cases, IBC may not generate additional emission (e.g., at the cost of EVM), and some of the significant peaks of a waveform may be removed. In some cases, the emission reduction benefit of IBC may be utilized in different manners. For example, since IBC may not generate emission, a subsequent CFR scheme (e.g., hard clipping) may be applied more aggressively and may further reduce PAPR. In another example, a better coexistence capability may be achieved without increasing PAPR of a waveform.

In the flow diagram 300, one or more samples of a wireless signal (e.g., input modulated symbols) may be processed by a first DFT block 310. In some examples, the first DFT block 310 may perform an M-point DFT (e.g., M-DFT) to transform the one or more samples from a time-domain (TD) to a frequency-domain (FD), where M may be associated with a size of frequency allocation (e.g., for a 60 RE allocation M=60). In some examples, the transformation at the first DFT block 310 may be performed in accordance with a sampling rate (e.g., a Nyquist sampling rate) that may be less than an upsampled sampling rate. The samples (e.g., FD samples) may be processed by a phase ramp block 315 (e.g., FD phase ramp), where a phase ramp function may be applied in the FD to the samples to shift the samples in the TD. In some examples, the phase ramp function may be represented as Equation 1.

$$ramp = exp ( - j \cdot 2 π \cdot \frac{0 : numRE - 1}{numRE} ) \cdot sampleShift ) \qquad ( 1 )$$

The samples may be processed by an inverse DFT (IDFT) block 320, where the IDFT block 320 may perform an M-point IDFT (e.g., M-IDFT) to transform the one or more samples from the FD to the TD, and the samples may be shifted samples in the TD (e.g., based on the phase ramp block 315). In some examples, the shifted samples may be midpoints (e.g., midpoints between integer Nyquist sample points) between peaks of the wireless signal based on applying the phase ramp function at the phase ramp block 315. The midpoint samples may be associated with relatively high PAPR and may be clipped to reduce PAPR of the wireless signal.

The samples may be processed by a first clipping block 325 (e.g., peak clipping), where each sample may be compared to a clipping threshold. If a sample exceeds the clipping threshold, the sample may be clipped to reduce the amplitude of the sample (e.g., the amplitude of the samples may be limited to a maximum value as defined by the clipping threshold). In some examples, an error margin between an original amplitude of a clipped sample and the clipping threshold may be referred to as noise (e.g., clipping noise). The samples (e.g., the clipped samples) may be processed by a second DFT block 335, which may perform a second M-point DFT (e.g., a second M-DFT) to transform the one or more samples from the TD to the FD. The samples may be processed by an undo phase ramp block 340, where the samples may be unshifted in the TD (e.g., a second phase ramp may be applied in the FD to shift the samples back to their original locations in the TD).

The samples may be processed by an IFFT block 345, where the samples may be transformed from the FD into the TD and may be output as discrete-time samples. In some examples, the operations of IFFT block 345 may further include cyclic prefix (CP) operations and window overlap and add (WOLA) operations (e.g., operations to add null samples to the samples from the wireless signal). The discrete time samples may be output to a second clipping block 350 (e.g., a hard clipper), where the samples may be further clipped to reduce PAPR.

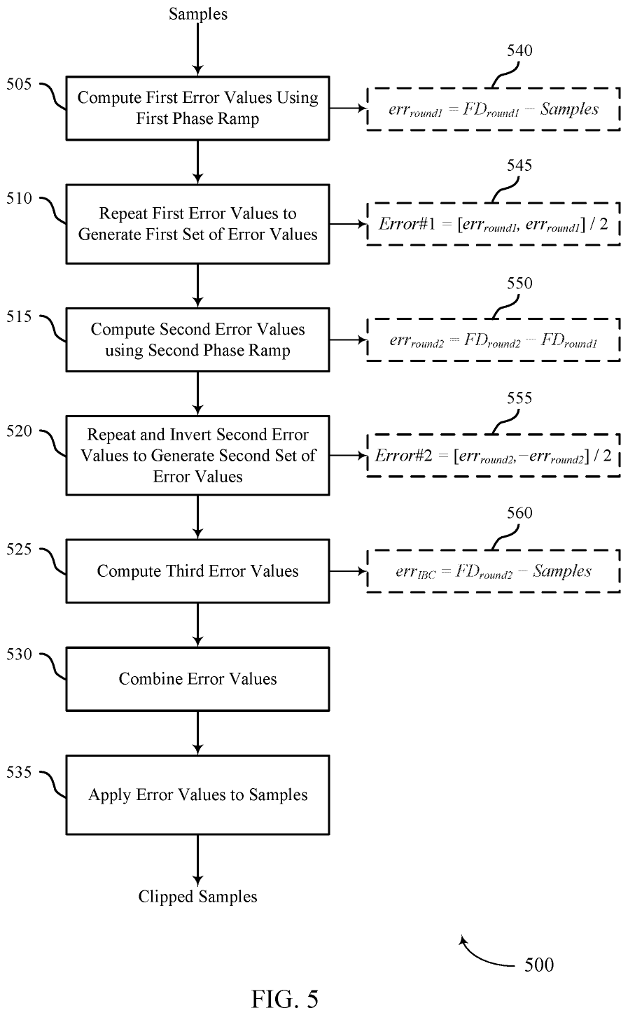

In some examples (e.g., for a DFT-s-OFDM waveform), a single round of IBC (e.g., a single round of processing blocks 360) with a first sample shift (e.g., a shift of 0.5) may be sufficient. However, for some other examples, multiple rounds of IBC (e.g., multiple applications of the processing blocks 360) may be performed. For instance, IBC may also be used for CP-OFDM by performing at least two rounds of IBC (e.g., due to CP-OFDM structure), where each round may have a different sampling shift (e.g., apply a different phase ramp function, or apply a phase ramp function with different parameters), as described in further detail elsewhere herein, including with reference to FIG. 5.

In some cases, a wireless device may be expected to satisfy one or more RF thresholds, which may refer to one or more performance metric values (e.g., PAPR, EVM, ACLR, IBE), as described with reference to FIG. 2. While applying IBC may cause a wireless device to exceed expectations for some RF thresholds (e.g., emissions, IBE), it may not exceed expectations for other RF thresholds (e.g., EVM). For example, IBC may cancel peaks of a wireless signal, but may introduce relatively wide TD sidelobes (e.g., resulting in no emissions but relatively high EVM). The sidelobes may be created when clipping noise is upsampled (e.g., due to interpolation).

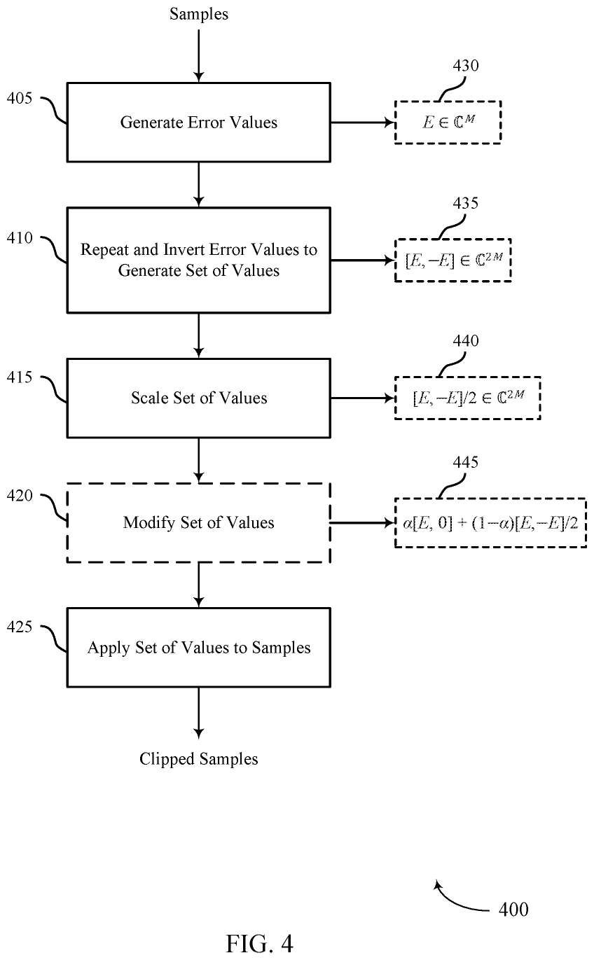

In accordance with techniques described herein, IBC techniques may be improved by including a noise repetition and shaping block 330 to perform one or more operations that repeat and shape the clipping noise (e.g., such that EVM is improved to open space for peak clipping). For instance, clipping noise may appear in odd sample indices (e.g., corresponding to 0.5-sample points at the original sampling rate, midpoints between integer Nyquist sample points). Accordingly, repeating the clipping noise (e.g., in the FD) and performing an IFFT (e.g., a 2× IFFT) may give the same peaks as IBC but without the sidelobes (e.g., in the TD). For example, the processing blocks 360 associated with IBC may include the noise repetition and shaping block 330, which may repeat and shape (e.g., scale) the noise values associated with the first clipping block 325. Additional operations associated with the noise repetition and shaping block 330 may be described in greater detail elsewhere herein, including with reference to FIG. 4.

Accordingly, processing one or more samples of a wireless communication signal with operations of the noise repetition and shaping block 330 may improve performance of a wireless communication device associated with one or more RF thresholds (e.g., may improve EVM).

FIG. 4 shows an example of a flow diagram 400 that supports techniques for IBC with noise repetition and shaping in accordance with one or more aspects of the present disclosure. In some examples, a network entity 105 (e.g., a gNB in downlink), a UE 115 (e.g., in uplink), or some other wireless device (e.g., a relay, a repeater, a CPE serving multiple users) as described herein may implement the operations of the flow diagram 400 to perform noise repetition and noise shaping. The flow diagram 400 may enable a wireless device to control a performance tradeoff associated with one or more RF thresholds associated with a wireless communication signal. The flow diagram 400 may illustrate operations for the noise repetition and noise shaping procedure 220 and the noise repetition and shaping block 330 as described with reference to FIGS. 2 and 3. For instance, one or more samples that are input at 405 may be associated with the output from the first clipping block 325 and the output at 425 may be associated with the input for the second DFT block 335. Although the flow diagram 400 includes single arrows between operations, it is to be understood that each operation may be simultaneously performed for multiple inputs (e.g., multiple samples at a time).

In some examples, at 405 a wireless device may generate (e.g., compute) error values (e.g., an error vector) based on one or more samples received at the input (e.g., M shifted samples from the phase ramp block 315 and the IDFT block 320). Each error value may correspond to an error margin between a respective sample of a wireless signal and a clipping threshold (e.g., error values may be the IBC clipping noise associated with the operations first clipping block 325). That is, the wireless device may apply a IBC (e.g., the clipping) to compute the error values. The error values may be represented by result 430 as a vector E∈ [symbol] ^{M}, as an example.

At 410, the wireless device may repeat and invert the error values (e.g., repeat the noise) to generate a set of values that include the original error values as well as the repeated and inverted values. The resulting set of values may be represented by result 435 as the set [E, −E]∈ [symbol] ^{2M}, as an example. At 415, the wireless device may apply a scalar (e.g., a scale factor) to set of values to further shape the noise, represented by the result 440 as [E, −E]/2∈ [symbol] ^{2M}. In this example, the scalar may be one half. However, it is to be understood that the scalar may be any scalar value. In some examples, the scalar may not be uniform for all error values. For example, different scalar values may be applied to respective error values of a set of error values.

At 420, the wireless device may (e.g., optionally) modify the set of values by applying a parameter to each value of the set of values, which may enable a wireless device to balance an EVM-emission performance tradeoff by further shaping the clipping noise (e.g., inside or outside of allocation). For instance, EVM and emissions may be balanced by utilizing different noise repetition and shaping kernels. A first kernel (e.g., Kernel #1) may include IBC with no repetition (e.g., a set [1,0]∈ [symbol] ^{2M} may be applied to the vector E∈ [symbol] ^{M}. The first kernel may be associated with little to no frequency emissions but with relatively degraded EVM. A second kernel (e.g., Kernel #2) may correspond to noise repetition and shaping with pure repetition (e.g., a set [1, −1]/2∈ [symbol] ^{2M} may be applied to the vector E∈ [symbol] ^{M}). The second kernel may improve EVM but may result in additional frequency emission.

In some examples, the wireless device may modify the set of values with a combination (e.g., a linear combination) of the first kernel and the second kernel. For example, the wireless device may apply a first parameter (e.g., α) to the first kernel and may apply a second parameter to a second kernel (e.g., 1−α) and may add the kernels together, producing the result 445 as α[E, 0]+(1−α)[E, −E]/2∈ [symbol] ^{2M}. In some examples, the combination may be simplified by a single parameter (e.g., [α+1, α−1]/2) which may be applied to the error vector, E (e.g., which may achieve an equivalent result to the result 445). In some examples, the parameter (e.g., α) may not be uniform for all error values in the error vector. For example, the parameter may be a different value for respective error values of the error vector.

In such examples, the parameter (e.g., or the one or more parameters) may control a tradeoff between emission and EVM. For example, if α=1, an IBC procedure without noise repetition may be applied, and, if α=0, an IBC procedure with pure noise repetition and shaping may be applied. However, if α is some other value (e.g., between 0 and 1), the wireless device may perform IBC with some combination of noise repetition and noise shaping, which may provide control over an EVM-emission tradeoff (e.g., as α increases, emissions may decrease and EVM may increase). In some examples, a value of the parameter may be based on an indicated change in one or more RF thresholds (e.g., based on the first control signaling 210).

As a non-limiting example (e.g., for the modification of the set of values at 420), the wireless device may modify the set of values (e.g., [E, −E]/2) by applying a parameter to each value of the set of values (e.g., (1−α)[E, −E]/2). The wireless device may generate a second set of values including the error values and one or more null values (e.g., [E, 0], in accordance with the first kernel). The wireless device may modify the second set of values by applying a second parameter to each value of the second set of values (e.g., α[E, 0]). The wireless device may then combine the modified set of values with the modified second set of values in accordance with a combination function (e.g., α[E, 0]+(1−α)[E, −E]/2). In some examples, the second set of values (e.g., [E, 0], an IBC portion) may be scaled independently from the set of values (e.g., [E, −E]/2, a noise repetition and shaping portion). For example, the second set of values may be scaled in accordance with a first parameter (e.g., α) and the set of values may be scaled in accordance with a second parameter (e.g., β) different than the first parameter.

In some examples, other functions (e.g., linear or non-linear functions having some slope) or parameters may be used to modify the set of values (e.g., at 420). In some examples, a shaper (e.g., a shaper function) may be selected (e.g., when IBE has extra budget), which may match an RF threshold. That is, to further reduce PAPR, noise shaping may be done such that the emissions in the immediate adjacent RBs may match an IBE mask. For instance, a wireless device may apply a respective value of the parameter (e.g., or a function) to each value of the set of values, where the respective value of the parameter may be based on an RB associated with a respective value of the set of values to which the parameter is being applied. For instance, in accordance with a shaper function (e.g., which achieves additional PAPR gain), the respective value may be represented as w₁=1*ones(1, N_{RE}) for one or more first RBs and be represented as

$${w}_{2} = 0.28 ( - 1.5 : \frac{0.5}{{N}_{RE}} : - 1 - \frac{0.5}{{N}_{RE}} )$$

for one or more second RBs. Accordingly, the parameter for modifying the set of values at 420 may, for example, be represented as [w₁, w₂]/2. Such a shaper function may be calculated to optimize PAPR gain while maintaining compliance with RF thresholds, such as the IBE mask.

At 425, the wireless device may apply the set of values to the samples (e.g., may apply the modified set of values to the samples). The application of the set of values may occur prior to an interpolation of the wireless communication signal. In some examples, applying the set of values to the samples may be based on modifying the set of values in accordance with the parameter (e.g., based on combining the modified set of values with the modified second set of values). In some examples, after application of the set of values to the samples, a vector (e.g., that includes the samples, a noise error vector after repetition) may have a relatively larger length. For example, the set of values may be applied to M samples, which may produce a vector with 2M samples. A first quantity, M, of the vector samples may be added to M input modulation symbols, while the remaining vector samples may be added over other resources (e.g., some resources outside of the allocation). Although the samples may be repeated by a factor of two (e.g., a 2× repetition), the samples may be repeated (e.g., noise repetition may be performed) by any factor (e.g., including larger factors).

Accordingly, a wireless device may apply one or more operations of the flow diagram 400 to control a performance tradeoff associated with one or more RF thresholds (e.g., an EVM-emission tradeoff). The noise shaping and noise repetition may be further applied to multiple waveforms types (e.g., single-carrier waveforms such as single carrier-frequency domain equalization (SC-FDE), minimum shift keying (MSK), Gaussian minimum shift keying (GMSK), and zero-tail DFT-s-OFDM (ZT-DFT-s-OFDM), multiple carrier waveforms such as CP-OFDM).

FIG. 5 shows an example of a flow diagram 500 that supports techniques for IBC with noise repetition and shaping in accordance with one or more aspects of the present disclosure. For example, the flow diagram 500 may enable a wireless device (e.g., a UE 115, a network entity 105) to perform the noise repetition and noise shaping techniques described herein for multiple carrier waveforms (e.g., CP-OFDM). The flow diagram 500 may illustrate further operations associated with the noise repetition and noise shaping procedure 220, the noise repetition and shaping block 330, and the flow diagram 400 as described with reference to FIGS. 2-4. For instance, one or more samples that are input at 505 may be associated with the output from the first clipping block 325 and the output at 535 may be associated with the input for the second DFT block 335 as described with reference to FIG. 3. Although the flow diagram 500 includes single arrows between operations, it is to be understood that each operation may be simultaneously performed for multiple inputs (e.g., multiple samples at a time).

In some examples, samples associated with multiple carrier waveforms may undergo multiple rounds of shifting and IBC before performing noise repetition and noise shaping. For example, at 505, a wireless device may compute first error values (e.g., err_{round1}) by applying a first phase ramp function (e.g., to quadrature amplitude modulation (QAM) symbols) to produce a result 540, represented as err_{round1}=F_{Dround1}−Samples, where the element “Samples” may refer to QAM symbols. The wireless device may apply IBC with sample shift of zero to obtain first FD samples (e.g., FD_{round1}). At 510, the wireless device may repeat (e.g., and apply a scalar to) the first error values to generate a first set of error values and produce a result 545, represented as Error #1=[err_{round1}, err_{round1}]/2.

At 515, the wireless device may compute a second set of error values (e.g., err_{round2}) by applying a second phase ramp function to the first FD samples (e.g., the wireless device may perform a second round of IBC using FD_{round1} as the input) to produce a result 550, represented as err_{round2}=FD_{round2}−FD_{round1}. For example, the wireless device may apply IBC to the samples with sample shift of 0.5 and may undo the second phase ramp function to obtain second FD samples (e.g., FD_{round2}). At 520, the wireless device may repeat and invert the second error values to generate a second set of error values and produce a result 555, represented as Error #2=[err_{round2}, −err_{round2}]/2. At 525, the wireless device may compute third error values (e.g., err_{IBC}), which may produce a result 560, represented as err_{IBC}=FD_{round2}−Samples.

At 530, the wireless device may combine the first set of error values, the second set of error values, and the third error values according to a combination function (e.g., a linear combination, a parameterized function). For example, a wireless device may combine a first kernel associated with the third error values and one or more null values (e.g., Kernel #1=[err_{IBC}, 0]), and a second kernel associated with the first set of error values and the second set of error values (e.g., Kernel #2=Error #1+Error #2). For noise repetition and shaping the first kernel and the second kernel may be combined using a parameter, α (e.g., kernels may be linearly combined as α.Kernel #1+(1−α). Kernel #2), where, if α=1, IBC with no noise repetition and shaping is applied, if α=0, IBC with pure noise repetition and shaping is applied, and if α is some other value, a combination of the two is applied (e.g., thus controlling a performance tradeoff). That is, the set of values that are applied to one or more samples of a wireless signal may be based on the first set of error values, the second set of error values, the third error values (e.g., which may be equivalent to an error margin between a respective sample and a clipping threshold), or any combination thereof.

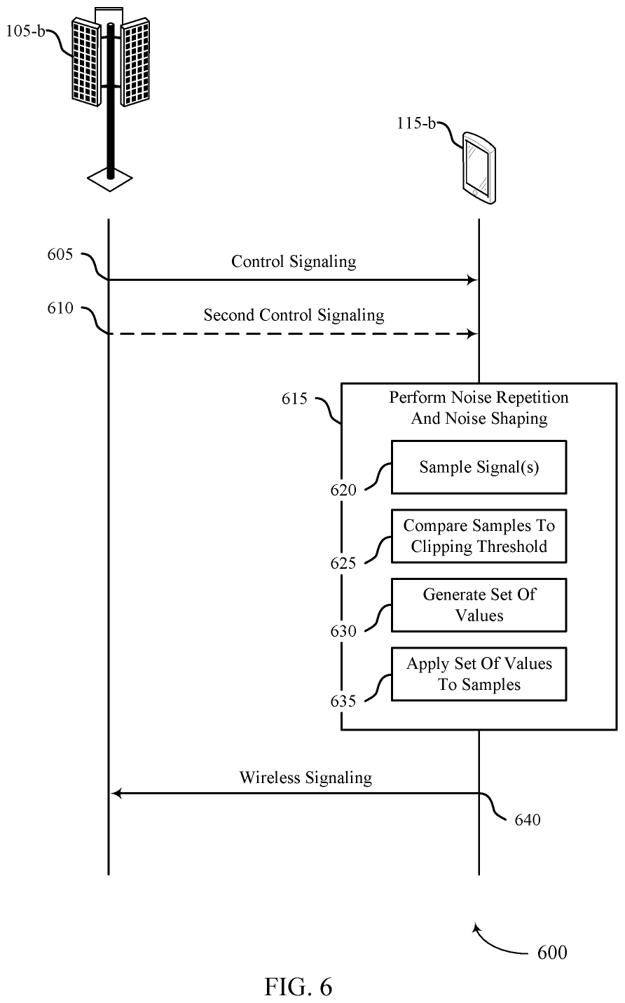

FIG. 6 shows an example of a process flow 600 that supports techniques for IBC with noise repetition and shaping in accordance with one or more aspects of the present disclosure. In some examples, process flow 600 may implement aspects of the wireless communications system 100, the wireless communications system 200, the flow diagram 300, the flow diagram 400, and the flow diagram 500. For example, the process flow 600 may include a network entity 105-b and a UE 115-b, which may be an example of corresponding devices as described herein. Additionally, the process flow 600 may support signaling between multiple devices to perform noise repetition and noise shaping based on a change in RF thresholds.

In the following description of the process flow 600, the operations performed by the network entity 105-b and the UE 115-b may be performed in different orders or at different times than the example order show. Some operations may also be omitted from the process flow 600, or other operations may be added to the process flow 600. Further, although some operations or signaling may be shown to occur at different times for discussion purposes, these operations may actually occur at the same time. While operations in the process flow 600 are illustrated as being performed by the network entity 105-b and the UE 115-b, the examples herein are not to be construed as limiting, as the described features may be associated with any quantity of different wireless communication devices.

At 605, the UE 115-b may receive control signaling that indicates a change in one or more RF thresholds (e.g., PAPR, IBE, EVM, ACLR, SEM) for wireless communications by the UE 115-b and/or the network entity 105-b. In some examples, the UE 115-b may receive, via the control signaling, information indicating an amount (e.g., a percentage, a quantity) by which at least one of the one or more RF thresholds is to change. In some examples, the UE 115-b may receive, via the control signaling, an indication that at least one of the one or more RF thresholds is not to be satisfied (e.g., an RF threshold is removed or relaxed). In some examples, the UE 115-b may receive the control signaling based on at least a channel type, or a modulation order, or a MCS, or a resource allocation size, or a resource allocation location, or a transmission rank, or a waveform type, or a frequency band, or a combination thereof associated with the wireless signaling

At 610, the UE 115-b may receive second control signaling that indicates a set of resources allocated for noise in accordance with the noise repetition and the noise shaping (e.g., allocated at edges of a channel bandwidth). For example, the set of resources may include resources allocated for an uplink control channel (e.g., a PUCCH). In some examples, one or more resources from among the set of resources may be dropped based on the one or more resources being external to a channel in a frequency domain. Although illustrated as separate control signaling, it is to be understood that, in some examples, the network entity 105-b may transmit an indication of the change in the one or more RF thresholds and the indication of the set of resources allocated for noise via a same control signal or message.

At 615, the UE 115-b may perform, during (e.g., or as part of) an IBC procedure, noise repetition and noise shaping to reduce a PAPR associated with the wireless signaling. In some examples, one or more parameters associated with the noise repetition and the noise shaping may be based on the change in the one or more RF thresholds. For example, the one or more parameters may include a parameter, α, (e.g., as described with reference to FIGS. 4 and 5) where the value of a may be determined based on the change in the one or more RF thresholds.

At 620, as part of the noise repetition and noise shaping, the UE 115-b may sample a wireless communication signal in accordance with a sampling rate (e.g., with a Nyquist sampling rate, without upsampling or oversampling the wireless signal). At 625, the UE 115-b may compare multiple samples to a clipping threshold (e.g., associated with an IBC procedure), where the multiple samples are obtained in accordance with the sampled wireless communication signal. The UE 115-b may generate (e.g., compute, identify, determine) one or more values to perform noise repetition and noise shaping in accordance with one or more aspects herein.

At 630, the UE 115-b may generate, based on the comparing, a set of values including one or more first values and one or more second values. In some examples, each first value of the one or more first values may be associated with an error margin between a respective sample of the plurality of samples and the clipping threshold (e.g., an error vector, a vector of clipping noise values). In some examples, each second value of the one or more second values may include an inversion of a respective first value (e.g., an inverted copy of a first value).

A wireless device may perform one or more additional operations as part of the noise repetition and noise shaping. For example, the UE 115-b may apply a scalar (e.g., ½) to the set of values. In some examples, the UE 115-b may modify the set of values by applying a parameter (e.g., (1−α), [α+1, α−1]/2) to each value of the set of values. In some examples, the UE 115-b may generate a second set of values including the one or more first values and one or more null values (e.g., one or more zeros). The UE 115-b may modify the second set of values by applying a second parameter (e.g., a) to each value of the second set of values. In some examples, the UE 115-b may combine the modified set of values with the modified second set of values in accordance with a combination function (e.g., α[E, 0]+(1−α)[E, −E]/2). In some examples, the UE 115-b may apply a respective value of the parameter to each value of the set of values, where the respective value of the parameter is based on an RB associated with a respective value of the set of values to which the parameter is being applied (e.g., in accordance with w₁ and w₂ as described with reference to FIG. 4).

In some examples, the UE 115-b may perform, prior to comparing the samples to the clipping threshold at 625, a first transformation (e.g., M-DFT) of the multiple samples from a TD to a FD. In some examples, the first transformation may be performed in accordance with the sampling rate, and the sampling rate may be less than an upsampled sampling rate (e.g., a Nyquist sampling rate). In some examples, the UE 115-b may apply a first phase ramp function to the multiple samples after the first transformation. The UE 115-b may perform a second transformation (e.g., M-IDFT) of the multiple samples from the FD to the TD. In some examples, each sample may shifted in the TD based on applying the first phase ramp function, and comparing the multiple samples to the clipping threshold may be based on the second transformation.

In some other examples (e.g., for multiple carrier waveforms), the UE 115-b may apply a first phase ramp function to the plurality of samples in a FD, where the first phase ramp function does not shift the plurality of samples in a TD. In such examples, the UE 115-b may generate a first set of error values (e.g., Error #1) based on applying the first phase ramp function. The UE 115-b may apply a second phase ramp function to the multiple samples after applying the first phase ramp function, where each sample of the multiple samples may be shifted in the TD based on applying the second phase ramp function. In some examples, the UE 115-b may generate a second set of error values (e.g., Error #2) based on generating the first set of error values and applying the second phase ramp function. In some examples, the set of values may be further based on the first set of error values, or the second set of error values, or the one or more first values (e.g., E, err_{IBC}), or a combination thereof, as described in further detail elsewhere herein, including with reference to FIG. 5.

At 635, the UE 115-b may apply the set of values to the multiple samples prior to an interpolation of the wireless communication signal (e.g., an interpolation from discrete-time samples to a continuous time signal). In some examples, applying the set of values to the multiple samples may be based on applying a scalar to the set of values. In some examples, applying the set of values to the multiple samples may be based on modifying the set of values (e.g., by combining the modified set of values with the modified second set of values) in accordance with the parameter (e.g., as described with reference to FIGS. 4 and 5).

At 640, the UE 115-b may transmit the wireless signaling via a channel, where the wireless signal may be associated with a performance tradeoff (e.g., between emissions and EVM, and associated with reduced PAPR) based on performing the noise repetition and shaping. Additionally, the UE 115-b may transmit the wireless signaling with improved PAPR reduction based on receiving the control signaling that indicates a change in one or more RF thresholds.

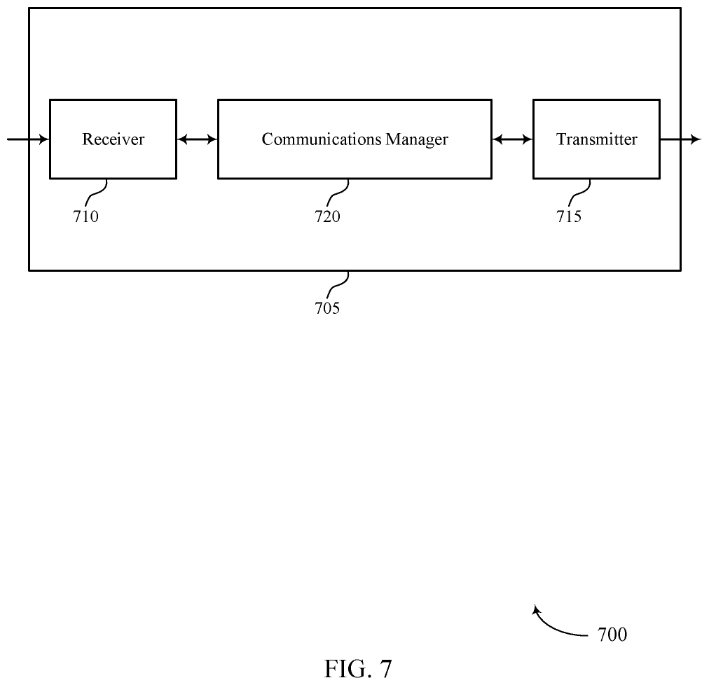

FIG. 7 shows a block diagram 700 of a device 705 that supports techniques for IBC with noise repetition and shaping in accordance with one or more aspects of the present disclosure. The device 705 may be an example of aspects of a wireless device as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Instructions that are executable by the one or more processors may be stored in the at least one memory to enable the one or more processors to perform the noise repetition and shaping features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for IBC with noise repetition and shaping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for IBC with noise repetition and shaping). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for IBC with noise repetition and shaping as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving control signaling that indicates a change in one or more radio frequency thresholds for wireless signaling by the wireless communication device. The communications manager 720 is capable of, configured to, or operable to support a means for performing, during an IBC procedure, noise repetition and noise shaping to reduce a peak-to-average power ratio associated with the wireless signaling, where one or more parameters associated with the noise repetition and the noise shaping are based on the change in the one or more radio frequency thresholds.

Additionally, or alternatively, the communications manager 720 may support wireless communication in accordance with examples as disclosed herein. For example, the communications manager 720 is capable of, configured to, or operable to support a means for sampling a wireless communication signal in accordance with a sampling rate. The communications manager 720 is capable of, configured to, or operable to support a means for comparing a set of multiple samples to a clipping threshold, where the set of multiple samples are obtained in accordance with the sampling. The communications manager 720 is capable of, configured to, or operable to support a means for generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. The communications manager 720 is capable of, configured to, or operable to support a means for applying the set of values to the set of multiple samples prior to an interpolation of the wireless communication signal.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

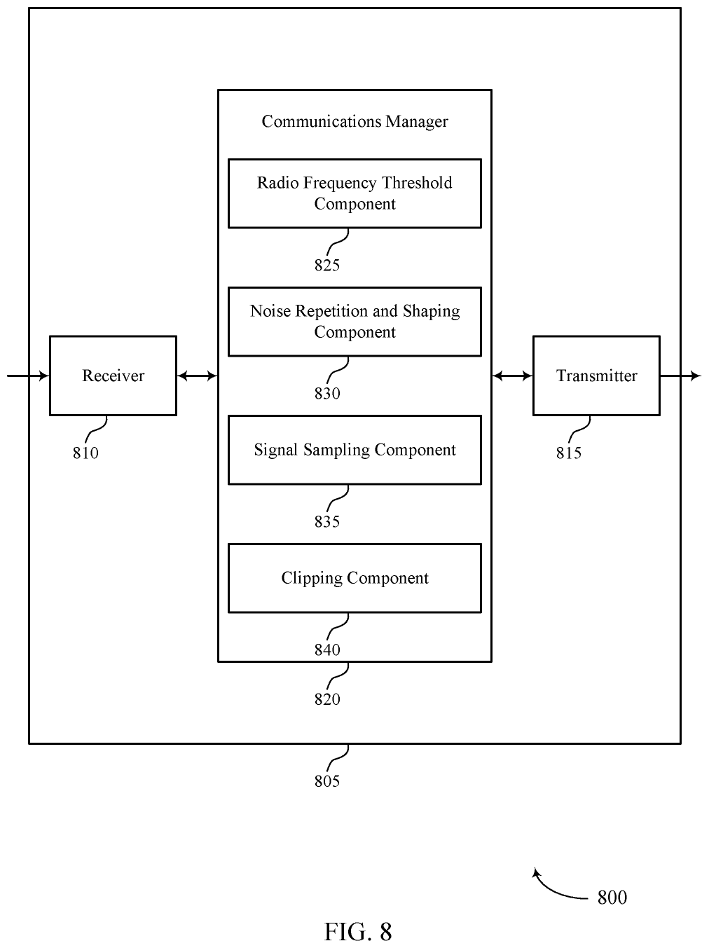

FIG. 8 shows a block diagram 800 of a device 805 that supports techniques for IBC with noise repetition and shaping in accordance with one or more aspects of the present disclosure. The device 805 may be an example of aspects of a device 705 or a wireless device (e.g., a UE 115) as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for IBC with noise repetition and shaping). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for IBC with noise repetition and shaping). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for IBC with noise repetition and shaping as described herein. For example, the communications manager 820 may include a radio frequency threshold component 825, a noise repetition and shaping component 830, a signal sampling component 835, a clipping component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The radio frequency threshold component 825 is capable of, configured to, or operable to support a means for receiving control signaling that indicates a change in one or more radio frequency thresholds for wireless signaling by the wireless communication device. The noise repetition and shaping component 830 is capable of, configured to, or operable to support a means for performing, during an IBC procedure, noise repetition and noise shaping to reduce a peak-to-average power ratio associated with the wireless signaling, where one or more parameters associated with the noise repetition and the noise shaping are based on the change in the one or more radio frequency thresholds.

Additionally, or alternatively, the communications manager 820 may support wireless communication in accordance with examples as disclosed herein. The signal sampling component 835 is capable of, configured to, or operable to support a means for sampling a wireless communication signal in accordance with a sampling rate. The clipping component 840 is capable of, configured to, or operable to support a means for comparing a set of multiple samples to a clipping threshold, where the set of multiple samples are obtained in accordance with the sampling. The noise repetition and shaping component 830 is capable of, configured to, or operable to support a means for generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. The clipping component 840 is capable of, configured to, or operable to support a means for applying the set of values to the set of multiple samples prior to an interpolation of the wireless communication signal.

In some cases, the radio frequency threshold component 825, the noise repetition and shaping component 830, the signal sampling component 835, and the clipping component 840 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the radio frequency threshold component 825, the noise repetition and shaping component 830, the signal sampling component 835, and the clipping component 840 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

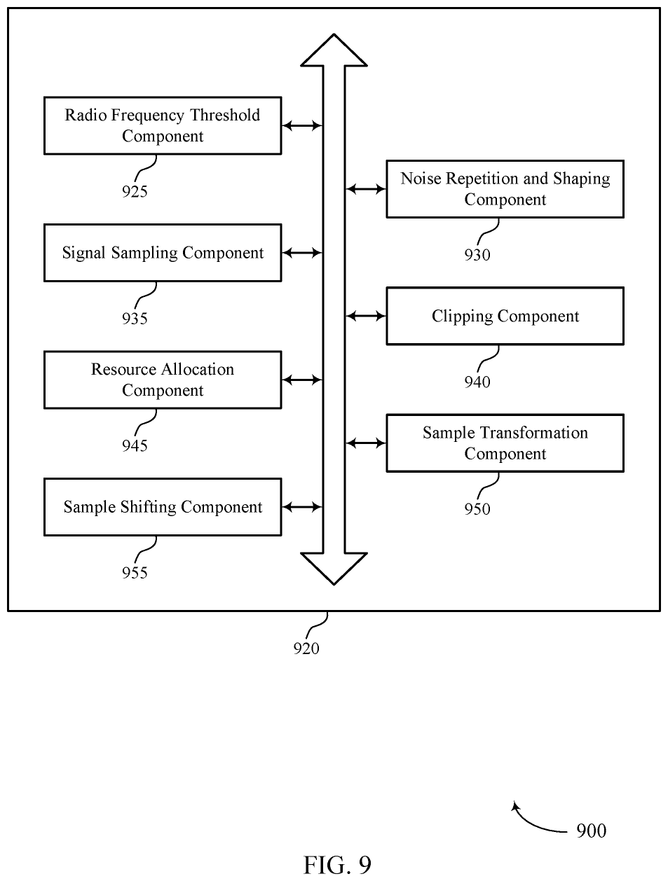

FIG. 9 shows a block diagram 900 of a communications manager 920 that supports techniques for IBC with noise repetition and shaping in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for IBC with noise repetition and shaping as described herein. For example, the communications manager 920 may include a radio frequency threshold component 925, a noise repetition and shaping component 930, a signal sampling component 935, a clipping component 940, a resource allocation component 945, a sample transformation component 950, a sample shifting component 955, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The radio frequency threshold component 925 is capable of, configured to, or operable to support a means for receiving control signaling that indicates a change in one or more radio frequency thresholds for wireless signaling by the wireless communication device. The noise repetition and shaping component 930 is capable of, configured to, or operable to support a means for performing, during an IBC procedure, noise repetition and noise shaping to reduce a peak-to-average power ratio associated with the wireless signaling, where one or more parameters associated with the noise repetition and the noise shaping are based on the change in the one or more radio frequency thresholds.

In some examples, the resource allocation component 945 is capable of, configured to, or operable to support a means for receiving second control signaling that indicates a set of resources allocated for noise in accordance with the noise repetition and the noise shaping. In some examples, the set of resources includes resources allocated for an uplink control channel.

In some examples, the resource allocation component 945 is capable of, configured to, or operable to support a means for transmitting the wireless signaling via a channel, where one or more resources from among the set of resources are dropped based on the one or more resources being external to the channel in a frequency domain.

In some examples, to support receiving the control signaling, the radio frequency threshold component 925 is capable of, configured to, or operable to support a means for receiving the control signaling indicating the change in the one or more radio frequency thresholds based on at least a channel type, or a modulation order, or a modulation and coding scheme, or a resource allocation size, or a resource allocation location, or a transmission rank, or a waveform type, or a frequency band, or a combination thereof associated with the wireless signaling.

In some examples, to support receiving the control signaling, the radio frequency threshold component 925 is capable of, configured to, or operable to support a means for receiving, via the control signaling, information indicating an amount by which at least one of the one or more radio frequency thresholds is to change.

In some examples, to support receiving the control signaling, the radio frequency threshold component 925 is capable of, configured to, or operable to support a means for receiving, via the control signaling, an indication that at least one of the one or more radio frequency thresholds is not to be satisfied by the wireless communication device.

In some examples, to support performing the noise repetition and the noise shaping, the signal sampling component 935 is capable of, configured to, or operable to support a means for sampling a wireless communication signal in accordance with a sampling rate. In some examples, to support performing the noise repetition and the noise shaping, the clipping component 940 is capable of, configured to, or operable to support a means for comparing a set of multiple samples to a clipping threshold, where the set of multiple samples are obtained in accordance with the sampling. In some examples, to support performing the noise repetition and the noise shaping, the noise repetition and shaping component 930 is capable of, configured to, or operable to support a means for generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. In some examples, to support performing the noise repetition and the noise shaping, the clipping component 940 is capable of, configured to, or operable to support a means for applying the set of values to the set of multiple samples prior to an interpolation of the wireless communication signal.

In some examples, the noise repetition and shaping component 930 is capable of, configured to, or operable to support a means for applying a scalar to the set of values, where applying the set of values to the set of multiple samples is based on applying the scalar.

In some examples, the noise repetition and shaping component 930 is capable of, configured to, or operable to support a means for modifying the set of values by applying a parameter to each value of the set of values, where applying the set of values to the set of multiple samples is based on modifying the set of values in accordance with the parameter.

In some examples, the noise repetition and shaping component 930 is capable of, configured to, or operable to support a means for generating a second set of values including the one or more first values and one or more null values. In some examples, the noise repetition and shaping component 930 is capable of, configured to, or operable to support a means for modifying the second set of values by applying a second parameter to each value of the second set of values. In some examples, the noise repetition and shaping component 930 is capable of, configured to, or operable to support a means for combining the modified set of values with the modified second set of values in accordance with a combination function, where applying the set of values is based on the combining.

In some examples, to support modifying the set of values, the noise repetition and shaping component 930 is capable of, configured to, or operable to support a means for applying a respective value of the parameter to each value of the set of values, where the respective value of the parameter is based on an RB associated with a respective value of the set of values to which the parameter is being applied.

In some examples, the sample transformation component 950 is capable of, configured to, or operable to support a means for performing, prior to the comparing, a first transformation of the set of multiple samples from a time domain to a frequency domain, where the first transformation is performed in accordance with the sampling rate, the sampling rate less than an upsampled sampling rate.

In some examples, the sample shifting component 955 is capable of, configured to, or operable to support a means for applying a first phase ramp function to the set of multiple samples after the first transformation. In some examples, the sample transformation component 950 is capable of, configured to, or operable to support a means for performing a second transformation of the set of multiple samples from the frequency domain to the time domain, where each sample of the set of multiple samples is shifted in the time domain based on applying the first phase ramp function, and where comparing the set of multiple samples to the clipping threshold is based on the second transformation.

In some examples, the sample shifting component 955 is capable of, configured to, or operable to support a means for applying a first phase ramp function to the set of multiple samples in a frequency domain, where the first phase ramp function does not shift the set of multiple samples in a time domain. In some examples, the noise repetition and shaping component 930 is capable of, configured to, or operable to support a means for generating a first set of error values based on applying the first phase ramp function. In some examples, the sample shifting component 955 is capable of, configured to, or operable to support a means for applying a second phase ramp function to the set of multiple samples after applying the first phase ramp function, where each sample of the set of multiple samples is shifted in the time domain based on applying the second phase ramp function. In some examples, the noise repetition and shaping component 930 is capable of, configured to, or operable to support a means for generating a second set of error values based on generating the first set of error values and applying the second phase ramp function, where the set of values is further based at least the first set of error values, or the second set of error values, or the one or more first values, or a combination thereof.

Additionally, or alternatively, the communications manager 920 may support wireless communication in accordance with examples as disclosed herein. The signal sampling component 935 is capable of, configured to, or operable to support a means for sampling a wireless communication signal in accordance with a sampling rate. The clipping component 940 is capable of, configured to, or operable to support a means for comparing a set of multiple samples to a clipping threshold, where the set of multiple samples are obtained in accordance with the sampling. In some examples, the noise repetition and shaping component 930 is capable of, configured to, or operable to support a means for generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. In some examples, the clipping component 940 is capable of, configured to, or operable to support a means for applying the set of values to the set of multiple samples prior to an interpolation of the wireless communication signal.

In some examples, the noise repetition and shaping component 930 is capable of, configured to, or operable to support a means for applying a scalar to the set of values, where applying the set of values to the set of multiple samples is based on applying the scalar.

In some examples, the noise repetition and shaping component 930 is capable of, configured to, or operable to support a means for modifying the set of values by applying a parameter to each value of the set of values, where applying the set of values to the set of multiple samples is based on modifying the set of values in accordance with the parameter.

In some examples, the noise repetition and shaping component 930 is capable of, configured to, or operable to support a means for generating a second set of values including the one or more first values and one or more null values. In some examples, the noise repetition and shaping component 930 is capable of, configured to, or operable to support a means for modifying the second set of values by applying a second parameter to each value of the second set of values. In some examples, the noise repetition and shaping component 930 is capable of, configured to, or operable to support a means for combining the modified set of values with the modified second set of values in accordance with a combination function, where applying the set of values is based on the combining.

In some examples, to support modifying the set of values, the noise repetition and shaping component 930 is capable of, configured to, or operable to support a means for applying a respective value of the parameter to each value of the set of values, where the respective value of the parameter is based on an RB associated with a respective value of the set of values to which the parameter is being applied.

In some examples, the sample transformation component 950 is capable of, configured to, or operable to support a means for performing, prior to the comparing, a first transformation of the set of multiple samples from a time domain to a frequency domain, where the first transformation is performed in accordance with the sampling rate, the sampling rate less than an upsampled sampling rate.

In some examples, the sample shifting component 955 is capable of, configured to, or operable to support a means for applying a first phase ramp function to the set of multiple samples after the first transformation. In some examples, the sample transformation component 950 is capable of, configured to, or operable to support a means for performing a second transformation of the set of multiple samples from the frequency domain to the time domain, where each sample of the set of multiple samples is shifted in the time domain based on applying the first phase ramp function, and where comparing the set of multiple samples to the clipping threshold is based on the second transformation.

In some examples, the sample shifting component 955 is capable of, configured to, or operable to support a means for applying a first phase ramp function to the set of multiple samples in a frequency domain, where the first phase ramp function does not shift the set of multiple samples in a time domain. In some examples, the noise repetition and shaping component 930 is capable of, configured to, or operable to support a means for generating a first set of error values based on applying the first phase ramp function. In some examples, the sample shifting component 955 is capable of, configured to, or operable to support a means for applying a second phase ramp function to the set of multiple samples after applying the first phase ramp function, where each sample of the set of multiple samples is shifted in the time domain based on applying the second phase ramp function. In some examples, the noise repetition and shaping component 930 is capable of, configured to, or operable to support a means for generating a second set of error values based on generating the first set of error values and applying the second phase ramp function, where the set of values is further based on at least the first set of error values, or the second set of error values, or the one or more first values, or a combination thereof.

In some cases, the radio frequency threshold component 925, the noise repetition and shaping component 930, the signal sampling component 935, the clipping component 940, the resource allocation component 945, the sample transformation component 950, and the sample shifting component 955 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the radio frequency threshold component 925, the noise repetition and shaping component 930, the signal sampling component 935, the clipping component 940, the resource allocation component 945, the sample transformation component 950, and the sample shifting component 955 discussed herein.

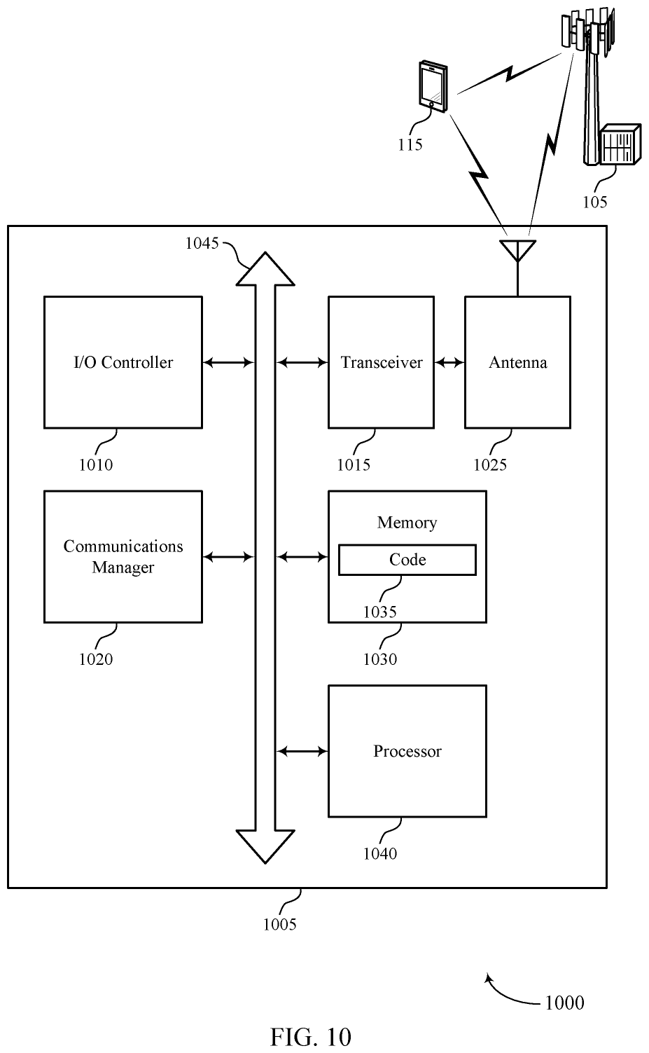

FIG. 10 shows a diagram of a system 1000 including a device 1005 that supports techniques for IBC with noise repetition and shaping in accordance with one or more aspects of the present disclosure. The device 1005 may be an example of or include the components of a device 705, a device 805, or a wireless device as described herein. The device 1005 may include components for bi-directional voice and data communications including components for transmitting and receiving communications, such as a communications manager 1020, an I/O controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include RAM and ROM. The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a BIOS which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for IBC with noise repetition and shaping). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving control signaling that indicates a change in one or more radio frequency thresholds for wireless signaling by the wireless communication device. The communications manager 1020 is capable of, configured to, or operable to support a means for performing, during an IBC procedure, noise repetition and noise shaping to reduce a peak-to-average power ratio associated with the wireless signaling, where one or more parameters associated with the noise repetition and the noise shaping are based on the change in the one or more radio frequency thresholds.

Additionally, or alternatively, the communications manager 1020 may support wireless communication in accordance with examples as disclosed herein. For example, the communications manager 1020 is capable of, configured to, or operable to support a means for sampling a wireless communication signal in accordance with a sampling rate. The communications manager 1020 is capable of, configured to, or operable to support a means for comparing a set of multiple samples to a clipping threshold, where the set of multiple samples are obtained in accordance with the sampling. The communications manager 1020 is capable of, configured to, or operable to support a means for generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. The communications manager 1020 is capable of, configured to, or operable to support a means for applying the set of values to the set of multiple samples prior to an interpolation of the wireless communication signal.

By including or configuring the communications manager 1020 in accordance with examples as described herein, the device 1005 may support techniques for improved communication reliability, more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for IBC with noise repetition and shaping as described herein, or the at least one processor 1040 and the at least one memory 1030 may be otherwise configured to, individually or collectively, perform or support such operations.

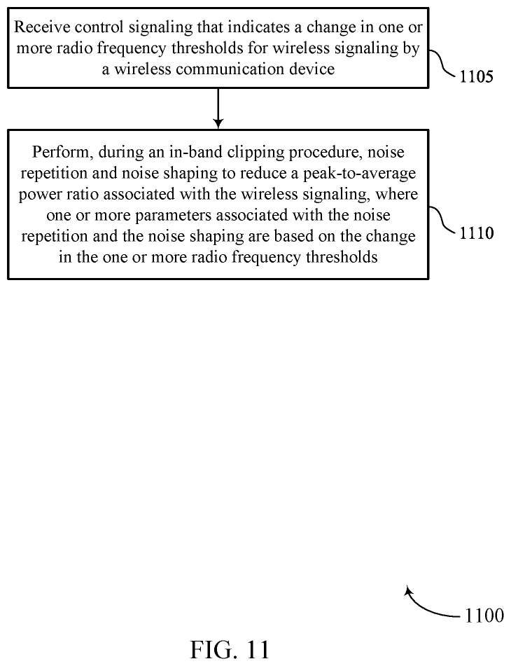

FIG. 11 shows a flowchart illustrating a method 1100 that supports techniques for IBC with noise repetition and shaping in accordance with aspects of the present disclosure. The operations of the method 1100 may be implemented by a wireless device or its components as described herein. For example, the operations of the method 1100 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1105, the method may include receiving control signaling that indicates a change in one or more radio frequency thresholds for wireless signaling by a wireless communication device. The operations of block 1105 may be performed in accordance with examples as disclosed herein. In some examples, aspects of the operations of 1105 may be performed by a radio frequency threshold component 925 as described with reference to FIG. 9.

At 1110, the method may include performing, during an IBC procedure, noise repetition and noise shaping to reduce a peak-to-average power ratio associated with the wireless signaling, where one or more parameters associated with the noise repetition and the noise shaping are based on the change in the one or more radio frequency thresholds. The operations of block 1110 may be performed in accordance with examples as disclosed herein. In some examples, aspects of the operations of 1110 may be performed by a noise repetition and shaping component 930 as described with reference to FIG. 9.

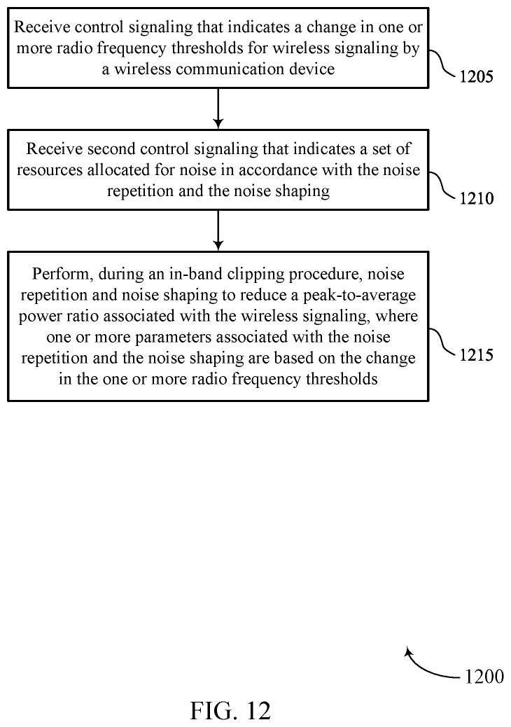

FIG. 12 shows a flowchart illustrating a method 1200 that supports techniques for IBC with noise repetition and shaping in accordance with aspects of the present disclosure. The operations of the method 1200 may be implemented by a wireless device or its components as described herein. For example, the operations of the method 1200 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1205, the method may include receiving control signaling that indicates a change in one or more radio frequency thresholds for wireless signaling by a wireless communication device. The operations of block 1205 may be performed in accordance with examples as disclosed herein. In some examples, aspects of the operations of 1205 may be performed by a radio frequency threshold component 925 as described with reference to FIG. 9.

At 1210, the method may include receiving second control signaling that indicates a set of resources allocated for noise in accordance with the noise repetition and the noise shaping. The operations of block 1210 may be performed in accordance with examples as disclosed herein. In some examples, aspects of the operations of 1210 may be performed by a resource allocation component 945 as described with reference to FIG. 9.

At 1215, the method may include performing, during an IBC procedure, noise repetition and noise shaping to reduce a peak-to-average power ratio associated with the wireless signaling, where one or more parameters associated with the noise repetition and the noise shaping are based on the change in the one or more radio frequency thresholds. The operations of block 1215 may be performed in accordance with examples as disclosed herein. In some examples, aspects of the operations of 1215 may be performed by a noise repetition and shaping component 930 as described with reference to FIG. 9.

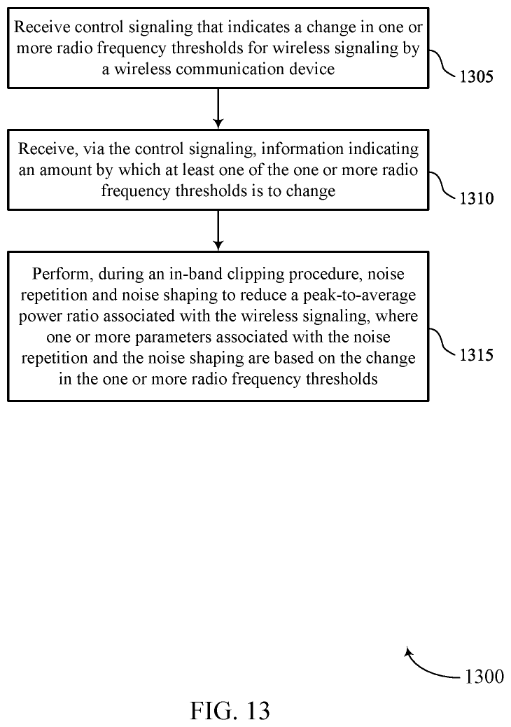

FIG. 13 shows a flowchart illustrating a method 1300 that supports techniques for IBC with noise repetition and shaping in accordance with aspects of the present disclosure. The operations of the method 1300 may be implemented by a wireless device or its components as described herein. For example, the operations of the method 1300 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1305, the method may include receiving control signaling that indicates a change in one or more radio frequency thresholds for wireless signaling by a wireless communication device. The operations of block 1305 may be performed in accordance with examples as disclosed herein. In some examples, aspects of the operations of 1305 may be performed by a radio frequency threshold component 925 as described with reference to FIG. 9.

At 1310, the method may include receiving, via the control signaling, information indicating an amount by which at least one of the one or more radio frequency thresholds is to change. The operations of block 1310 may be performed in accordance with examples as disclosed herein. In some examples, aspects of the operations of 1310 may be performed by a radio frequency threshold component 925 as described with reference to FIG. 9.

At 1315, the method may include performing, during an IBC procedure, noise repetition and noise shaping to reduce a peak-to-average power ratio associated with the wireless signaling, where one or more parameters associated with the noise repetition and the noise shaping are based on the change in the one or more radio frequency thresholds. The operations of block 1315 may be performed in accordance with examples as disclosed herein. In some examples, aspects of the operations of 1315 may be performed by a noise repetition and shaping component 930 as described with reference to FIG. 9.

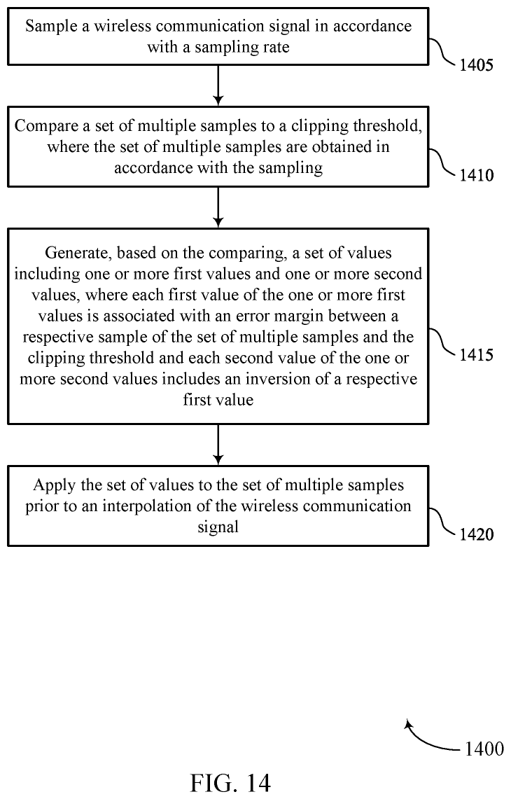

FIG. 14 shows a flowchart illustrating a method 1400 that supports techniques for IBC with noise repetition and shaping in accordance with aspects of the present disclosure. The operations of the method 1400 may be implemented by a wireless device or its components as described herein. For example, the operations of the method 1400 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1405, the method may include sampling a wireless communication signal in accordance with a sampling rate. The operations of block 1405 may be performed in accordance with examples as disclosed herein. In some examples, aspects of the operations of 1405 may be performed by a signal sampling component 935 as described with reference to FIG. 9.

At 1410, the method may include comparing a set of multiple samples to a clipping threshold, where the set of multiple samples are obtained in accordance with the sampling. The operations of block 1410 may be performed in accordance with examples as disclosed herein. In some examples, aspects of the operations of 1410 may be performed by a clipping component 940 as described with reference to FIG. 9.

At 1415, the method may include generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. The operations of block 1415 may be performed in accordance with examples as disclosed herein. In some examples, aspects of the operations of 1415 may be performed by a noise repetition and shaping component 930 as described with reference to FIG. 9.

At 1420, the method may include applying the set of values to the set of multiple samples prior to an interpolation of the wireless communication signal. The operations of block 1420 may be performed in accordance with examples as disclosed herein. In some examples, aspects of the operations of 1420 may be performed by a clipping component 940 as described with reference to FIG. 9.

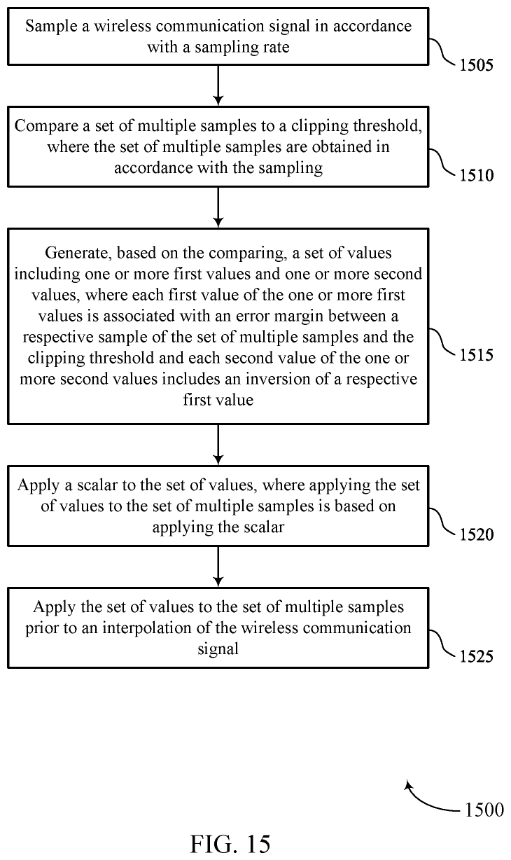

FIG. 15 shows a flowchart illustrating a method 1500 that supports techniques for IBC with noise repetition and shaping in accordance with aspects of the present disclosure. The operations of the method 1500 may be implemented by a wireless device or its components as described herein. For example, the operations of the method 1500 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1505, the method may include sampling a wireless communication signal in accordance with a sampling rate. The operations of block 1505 may be performed in accordance with examples as disclosed herein. In some examples, aspects of the operations of 1505 may be performed by a signal sampling component 935 as described with reference to FIG. 9.

At 1510, the method may include comparing a set of multiple samples to a clipping threshold, where the set of multiple samples are obtained in accordance with the sampling. The operations of block 1510 may be performed in accordance with examples as disclosed herein. In some examples, aspects of the operations of 1510 may be performed by a clipping component 940 as described with reference to FIG. 9.

At 1515, the method may include generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. The operations of block 1515 may be performed in accordance with examples as disclosed herein. In some examples, aspects of the operations of 1515 may be performed by a noise repetition and shaping component 930 as described with reference to FIG. 9.

At 1520, the method may include applying a scalar to the set of values, where applying the set of values to the set of multiple samples is based on applying the scalar. The operations of block 1520 may be performed in accordance with examples as disclosed herein. In some examples, aspects of the operations of 1520 may be performed by a noise repetition and shaping component 930 as described with reference to FIG. 9.

At 1525, the method may include applying the set of values to the set of multiple samples prior to an interpolation of the wireless communication signal. The operations of block 1525 may be performed in accordance with examples as disclosed herein. In some examples, aspects of the operations of 1525 may be performed by a clipping component 940 as described with reference to FIG. 9.

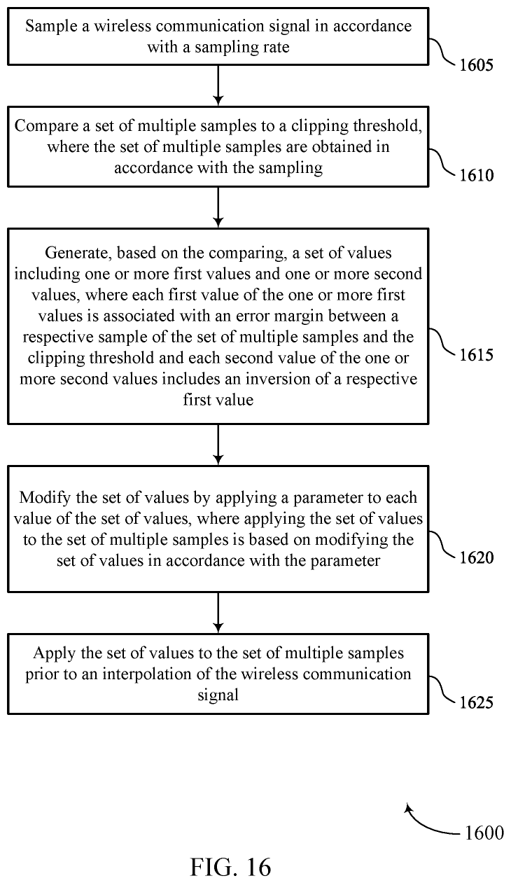

FIG. 16 shows a flowchart illustrating a method 1600 that supports techniques for IBC with noise repetition and shaping in accordance with aspects of the present disclosure. The operations of the method 1600 may be implemented by a wireless device or its components as described herein. For example, the operations of the method 1600 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1605, the method may include sampling a wireless communication signal in accordance with a sampling rate. The operations of block 1605 may be performed in accordance with examples as disclosed herein. In some examples, aspects of the operations of 1605 may be performed by a signal sampling component 935 as described with reference to FIG. 9.

At 1610, the method may include comparing a set of multiple samples to a clipping threshold, where the set of multiple samples are obtained in accordance with the sampling. The operations of block 1610 may be performed in accordance with examples as disclosed herein. In some examples, aspects of the operations of 1610 may be performed by a clipping component 940 as described with reference to FIG. 9.

At 1615, the method may include generating, based on the comparing, a set of values including one or more first values and one or more second values, where each first value of the one or more first values is associated with an error margin between a respective sample of the set of multiple samples and the clipping threshold and each second value of the one or more second values includes an inversion of a respective first value. The operations of block 1615 may be performed in accordance with examples as disclosed herein. In some examples, aspects of the operations of 1615 may be performed by a noise repetition and shaping component 930 as described with reference to FIG. 9.

At 1620, the method may include modifying the set of values by applying a parameter to each value of the set of values, where applying the set of values to the set of multiple samples is based on modifying the set of values in accordance with the parameter. The operations of block 1620 may be performed in accordance with examples as disclosed herein. In some examples, aspects of the operations of 1620 may be performed by a noise repetition and shaping component 930 as described with reference to FIG. 9.

At 1625, the method may include applying the set of values to the set of multiple samples prior to an interpolation of the wireless communication signal. The operations of block 1625 may be performed in accordance with examples as disclosed herein. In some examples, aspects of the operations of 1625 may be performed by a clipping component 940 as described with reference to FIG. 9.

The following provides an overview of aspects of the present disclosure:

Aspect 1: A method for wireless communication by a wireless communication device, comprising: receiving control signaling that indicates a change in one or more RF thresholds for wireless signaling by the wireless communication device; and performing, during an IBC procedure, noise repetition and noise shaping to reduce a PAPR associated with the wireless signaling, wherein one or more parameters associated with the noise repetition and the noise shaping are based at least in part on the change in the one or more RF thresholds.

Aspect 2: The method of aspect 1, further comprising: receiving second control signaling that indicates a set of resources allocated for noise in accordance with the noise repetition and the noise shaping.

Aspect 3: The method of aspect 2, wherein the set of resources comprises resources allocated for an uplink control channel.

Aspect 4: The method of any of aspects 2 through 3, further comprising: transmitting the wireless signaling via a channel, wherein one or more resources from among the set of resources are dropped based at least in part on the one or more resources being external to the channel in a frequency domain.

Aspect 5: The method of any of aspects 1 through 4, wherein receiving the control signaling comprises: receive the control signaling indicating the change in the one or more RF thresholds based at least in part on at least a channel type, or a modulation order, or an MCS, or a resource allocation size, or a resource allocation location, or a transmission rank, or a waveform type, or a frequency band, or a combination thereof associated with the wireless signaling.

Aspect 6: The method of any of aspects 1 through 5, wherein receiving the control signaling comprises: receiving, via the control signaling, information indicating an amount by which at least one of the one or more RF thresholds is to change.

Aspect 7: The method of any of aspects 1 through 6, wherein receiving the control signaling comprises: receiving, via the control signaling, an indication that at least one of the one or more RF thresholds is not to be satisfied by the wireless communication device.

Aspect 8: The method of any of aspects 1 through 7, wherein performing the noise repetition and the noise shaping comprises: sampling a wireless communication signal in accordance with a sampling rate; comparing a plurality of samples to a clipping threshold, wherein the plurality of samples are obtained in accordance with the sampling; generating, based at least in part on the comparing, a set of values comprising one or more first values and one or more second values, wherein each first value of the one or more first values is associated with an error margin between a respective sample of the plurality of samples and the clipping threshold and each second value of the one or more second values comprises an inversion of a respective first value; and applying the set of values to the plurality of samples prior to an interpolation of the wireless communication signal.

Aspect 9: The method of aspect 8, further comprising: applying a scalar to the set of values, wherein applying the set of values to the plurality of samples is based at least in part on applying the scalar.

Aspect 10: The method of any of aspects 8 through 9, further comprising: modifying the set of values by applying a parameter to each value of the set of values, wherein applying the set of values to the plurality of samples is based at least in part on modifying the set of values in accordance with the parameter.

Aspect 11: The method of aspect 10, further comprising: generating a second set of values comprising the one or more first values and one or more null values; modifying the second set of values by applying a second parameter to each value of the second set of values; and combining the modified set of values with the modified second set of values in accordance with a combination function, wherein applying the set of values is based at least in part on the combining.

Aspect 12: The method of any of aspects 10 through 11, wherein modifying the set of values comprises: applying a respective value of the parameter to each value of the set of values, wherein the respective value of the parameter is based at least in part on an RB associated with a respective value of the set of values to which the parameter is being applied.

Aspect 13: The method of any of aspects 8 through 12, further comprising: performing, prior to the comparing, a first transformation of the plurality of samples from a time domain to a frequency domain, wherein the first transformation is performed in accordance with the sampling rate, the sampling rate less than an upsampled sampling rate.

Aspect 14: The method of aspect 13, further comprising: applying a first phase ramp function to the plurality of samples after the first transformation; and performing a second transformation of the plurality of samples from the frequency domain to the time domain, wherein each sample of the plurality of samples is shifted in the time domain based at least in part on applying the first phase ramp function, and wherein comparing the plurality of samples to the clipping threshold is based at least in part on the second transformation.

Aspect 15: The method of any of aspects 8 through 10, 13, or 14, further comprising: applying a first phase ramp function to the plurality of samples in a frequency domain, wherein the first phase ramp function does not shift the plurality of samples in a time domain; generating a first set of error values based at least in part on applying the first phase ramp function; applying a second phase ramp function to the plurality of samples after applying the first phase ramp function, wherein each sample of the plurality of samples is shifted in the time domain based at least in part on applying the second phase ramp function; and generate a second set of error values based at least in part on generating the first set of error values and applying the second phase ramp function, wherein the set of values is further based at least in part on at least the first set of error values, or the second set of error values, or the one or more first values, or a combination thereof.

Aspect 16: A method for wireless communication by a wireless communication device, comprising: sampling a wireless communication signal in accordance with a sampling rate; comparing a plurality of samples to a clipping threshold, wherein the plurality of samples are obtained in accordance with the sampling; generating, based at least in part on the comparing, a set of values comprising one or more first values and one or more second values, wherein each first value of the one or more first values is associated with an error margin between a respective sample of the plurality of samples and the clipping threshold and each second value of the one or more second values comprises an inversion of a respective first value; and applying the set of values to the plurality of samples prior to an interpolation of the wireless communication signal.

Aspect 17: The method of aspect 16, further comprising: applying a scalar to the set of values, wherein applying the set of values to the plurality of samples is based at least in part on applying the scalar.

Aspect 18: The method of any of aspects 16 through 17, further comprising: modifying the set of values by applying a parameter to each value of the set of values, wherein applying the set of values to the plurality of samples is based at least in part on modifying the set of values in accordance with the parameter.

Aspect 19: The method of aspect 18, further comprising: generating a second set of values comprising the one or more first values and one or more null values; modifying the second set of values by applying a second parameter to each value of the second set of values; and combining the modified set of values with the modified second set of values in accordance with a combination function, wherein applying the set of values is based at least in part on the combining.

Aspect 20: The method of any of aspects 18 through 19, wherein modifying the set of values comprises: applying a respective value of the parameter to each value of the set of values, wherein the respective value of the parameter is based at least in part on an RB associated with a respective value of the set of values to which the parameter is being applied.

Aspect 21: The method of any of aspects 16 through 20, further comprising: performing, prior to the comparing, a first transformation of the plurality of samples from a time domain to a frequency domain, wherein the first transformation is performed in accordance with the sampling rate, the sampling rate less than an upsampled sampling rate.

Aspect 22: The method of aspect 21, further comprising: applying a first phase ramp function to the plurality of samples after the first transformation; and performing a second transformation of the plurality of samples from the frequency domain to the time domain, wherein each sample of the plurality of samples is shifted in the time domain based at least in part on applying the first phase ramp function, and wherein comparing the plurality of samples to the clipping threshold is based at least in part on the second transformation.

Aspect 23: The method of any of aspects 16 through 18, 21, or 22, further comprising: applying a first phase ramp function to the plurality of samples in a frequency domain, wherein the first phase ramp function does not shift the plurality of samples in a time domain; generating a first set of error values based at least in part on applying the first phase ramp function; applying a second phase ramp function to the plurality of samples after applying the first phase ramp function, wherein each sample of the plurality of samples is shifted in the time domain based at least in part on applying the second phase ramp function; and generate a second set of error values based at least in part on generating the first set of error values and applying the second phase ramp function, wherein the set of values is further based at least in part on at least the first set of error values, or the second set of error values, or the one or more first values, or a combination thereof.

Aspect 24: A wireless communication device for wireless communication, comprising one or more memories storing processor-executable code, and one or more processors coupled with the one or more memories and individually or collectively operable to execute the code to cause the wireless communication device to perform a method of any of aspects 1 through 15.

Aspect 25: A wireless communication device for wireless communication, comprising at least one means for performing a method of any of aspects 1 through 15.

Aspect 26: A non-transitory computer-readable medium storing code for wireless communication, the code comprising instructions executable by one or more processors to perform a method of any of aspects 1 through 15.

Aspect 27: A wireless communication device for wireless communication, comprising one or more memories storing processor-executable code, and one or more processors coupled with the one or more memories and individually or collectively operable to execute the code to cause the wireless communication device to perform a method of any of aspects 16 through 23.

Aspect 28: A wireless communication device for wireless communication, comprising at least one means for performing a method of any of aspects 16 through 23.

Aspect 29: A non-transitory computer-readable medium storing code for wireless communication, the code comprising instructions executable by one or more processors to perform a method of any of aspects 16 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communication device, comprising:
one or more memories storing processor-executable code; and
one or more processors coupled with the one or more memories, wherein the one or more processors are individually or collectively configured to cause the wireless communication device to:
receive control signaling that indicates a change in one or more radio frequency thresholds for wireless signaling by the wireless communication device; and
perform, during an in-band clipping procedure, noise repetition and noise shaping to reduce a peak-to-average power ratio associated with the wireless signaling, wherein one or more parameters associated with the noise repetition and the noise shaping are based at least in part on the change in the one or more radio frequency thresholds.

2. The wireless communication device of claim 1, wherein the one or more processors are individually or collectively further configured to cause the wireless communication device to:
receive second control signaling that indicates a set of resources allocated for noise in accordance with the noise repetition and the noise shaping.

3. The wireless communication device of claim 2, wherein the set of resources comprises resources allocated for an uplink control channel.

4. The wireless communication device of claim 2, wherein the one or more processors are individually or collectively further configured to cause the wireless communication device to:
transmit the wireless signaling via a channel, wherein one or more resources from among the set of resources are dropped based at least in part on the one or more resources being external to the channel in a frequency domain.

5. The wireless communication device of claim 1, wherein the one or more processors are individually or collectively configured to cause the wireless communication device to receive the control signaling by being individually or collectively configured to cause the wireless communication device to:
receive the control signaling indicating the change in the one or more radio frequency thresholds based at least in part on at least a channel type, or a modulation order, or a modulation and coding scheme, or a resource allocation size, or a resource allocation location, or a transmission rank, or a waveform type, or a frequency band, or a combination thereof associated with the wireless signaling.

6. The wireless communication device of claim 1, wherein the one or more processors are individually or collectively configured to cause the wireless communication device to receive the control signaling by being individually or collectively configured to cause the wireless communication device to:
receive, via the control signaling, information indicating an amount by which at least one of the one or more radio frequency thresholds is to change.

7. The wireless communication device of claim 1, wherein the one or more processors are individually or collectively configured to cause the wireless communication device to receive the control signaling by being individually or collectively configured to cause the wireless communication device to:
receive, via the control signaling, an indication that at least one of the one or more radio frequency thresholds is not to be satisfied by the wireless communication device.

8. The wireless communication device of claim 1, wherein the one or more processors are individually or collectively configured to cause the wireless communication device to perform the noise repetition and the noise shaping by being individually or collectively configured to cause the wireless communication device to:
sample a wireless communication signal in accordance with a sampling rate;
compare a plurality of samples to a clipping threshold, wherein the plurality of samples are obtained in accordance with the sampled wireless communication signal;
generate, based at least in part on the comparison, a set of values comprising one or more first values and one or more second values, wherein each first value of the one or more first values is associated with an error margin between a respective sample of the plurality of samples and the clipping threshold and each second value of the one or more second values comprises an inversion of a respective first value; and
apply the set of values to the plurality of samples prior to an interpolation of the wireless communication signal.

9. The wireless communication device of claim 8, wherein the one or more processors are individually or collectively further configured to cause the wireless communication device to:
apply a scalar to the set of values, wherein the application of the set of values to the plurality of samples is based at least in part on the application of the scalar.

10. The wireless communication device of claim 8, wherein the one or more processors are individually or collectively further configured to cause the wireless communication device to:
modify the set of values by application of a parameter to each value of the set of values, wherein the application of the set of values to the plurality of samples is based at least in part on the modification of the set of values in accordance with the parameter.

11. The wireless communication device of claim 10, wherein the one or more processors are individually or collectively further configured to cause the wireless communication device to:
generate a second set of values comprising the one or more first values and one or more null values;
modify the second set of values by application of a second parameter to each value of the second set of values; and
combine the modified set of values with the modified second set of values in accordance with a combination function, wherein the application of the set of values is based at least in part on the combination of the modified set of values with the modified second set of values.

12. The wireless communication device of claim 10, wherein the one or more processors are individually or collectively configured to cause the wireless communication device to modify the set of values by being individually or collectively configured to cause the wireless communication device to:
apply a respective value of the parameter to each value of the set of values, wherein the respective value of the parameter is based at least in part on a resource block associated with a respective value of the set of values to which the parameter is being applied.

13. The wireless communication device of claim 8, wherein the one or more processors are individually or collectively further configured to cause the wireless communication device to:
perform, prior to the comparison, a first transformation of the plurality of samples from a time domain to a frequency domain, wherein the first transformation is performed in accordance with the sampling rate, the sampling rate less than an upsampled sampling rate.

14. The wireless communication device of claim 13, wherein the one or more processors are individually or collectively further configured to cause the wireless communication device to:
apply a first phase ramp function to the plurality of samples after the first transformation; and
perform a second transformation of the plurality of samples from the frequency domain to the time domain, wherein each sample of the plurality of samples is shifted in the time domain based at least in part on the application of the first phase ramp function, and wherein the comparison of the plurality of samples to the clipping threshold is based at least in part on the second transformation.

15. The wireless communication device of claim 8, wherein the one or more processors are individually or collectively further configured to cause the wireless communication device to:
apply a first phase ramp function to the plurality of samples in a frequency domain, wherein the first phase ramp function does not shift the plurality of samples in a time domain;
generate a first set of error values based at least in part on the application of the first phase ramp function;
apply a second phase ramp function to the plurality of samples after the application of the first phase ramp function, wherein each sample of the plurality of samples is shifted in the time domain based at least in part on the application of the second phase ramp function; and
generate a second set of error values based at least in part on the generation of the first set of error values and the application of the second phase ramp function, wherein the set of values is further based at least in part on at least the first set of error values, or the second set of error values, or the one or more first values, or a combination thereof.

16. A wireless communication device, comprising:
one or more memories storing processor-executable code; and
one or more processors coupled with the one or more memories, wherein the one or more processors are individually or collectively configured to cause the wireless communication device to:
sample a wireless communication signal in accordance with a sampling rate;
compare a plurality of samples to a clipping threshold, wherein the plurality of samples are obtained in accordance with the sampled wireless communication signal;
generate, based at least in part on the comparison, a set of values comprising one or more first values and one or more second values, wherein each first value of the one or more first values is associated with an error margin between a respective sample of the plurality of samples and the clipping threshold and each second value of the one or more second values comprises an inversion of a respective first value; and
apply the set of values to the plurality of samples prior to an interpolation of the wireless communication signal.

17. The wireless communication device of claim 16, wherein the one or more processors are individually or collectively further configured to cause the wireless communication device to:
apply a scalar to the set of values, wherein the application of the set of values to the plurality of samples is based at least in part on the application of the scalar.

18. The wireless communication device of claim 16, wherein the one or more processors are individually or collectively further configured to cause the wireless communication device to:
modify the set of values by application of a parameter to each value of the set of values, wherein the application of the set of values to the plurality of samples is based at least in part on the modification of the set of values in accordance with the parameter.

19. The wireless communication device of claim 18, wherein the one or more processors are individually or collectively further configured to cause the wireless communication device to:
generate a second set of values comprising the one or more first values and one or more null values;
modify the second set of values by application of a second parameter to each value of the second set of values; and
combine the modified set of values with the modified second set of values in accordance with a combination function, wherein the application of the set of values is based at least in part on the combination of the modified set of values with the modified second set of values.

20. The wireless communication device of claim 18, wherein the one or more processors are individually or collectively configured to cause the wireless communication device to modify the set of values by being individually or collectively configured to cause the wireless communication device to:
apply a respective value of the parameter to each value of the set of values, wherein the respective value of the parameter is based at least in part on a resource block associated with a respective value of the set of values to which the parameter is being applied.

21. The wireless communication device of claim 16, wherein the one or more processors are individually or collectively further configured to cause the wireless communication device to:
perform, prior to the comparison, a first transformation of the plurality of samples from a time domain to a frequency domain, wherein the first transformation is performed in accordance with the sampling rate, the sampling rate less than an upsampled sampling rate.

22. The wireless communication device of claim 21, wherein the one or more processors are individually or collectively further configured to cause the wireless communication device to:
apply a first phase ramp function to the plurality of samples after the first transformation; and
perform a second transformation of the plurality of samples from the frequency domain to the time domain, wherein each sample of the plurality of samples is shifted in the time domain based at least in part on the application of the first phase ramp function, and wherein the comparison of the plurality of samples to the clipping threshold is based at least in part on the second transformation.

23. The wireless communication device of claim 16, wherein the one or more processors are individually or collectively further configured to cause the wireless communication device to:
apply a first phase ramp function to the plurality of samples in a frequency domain, wherein the first phase ramp function does not shift the plurality of samples in a time domain;
generate a first set of error values based at least in part on the application of the first phase ramp function;
apply a second phase ramp function to the plurality of samples after the application of the first phase ramp function, wherein each sample of the plurality of samples is shifted in the time domain based at least in part on the application of the second phase ramp function; and
generate a second set of error values based at least in part on the generation of the first set of error values and the application of the second phase ramp function, wherein the set of values is further based at least in part on at least the first set of error values, or the second set of error values, or the one or more first values, or a combination thereof.

24. A method for wireless communication by a wireless communication device, comprising:
receiving control signaling that indicates a change in one or more radio frequency thresholds for wireless signaling by the wireless communication device; and
performing, during an in-band clipping procedure, noise repetition and noise shaping to reduce a peak-to-average power ratio associated with the wireless signaling, wherein one or more parameters associated with the noise repetition and the noise shaping are based at least in part on the change in the one or more radio frequency thresholds.

25. The method of claim 24, further comprising:
receiving second control signaling that indicates a set of resources allocated for noise in accordance with the noise repetition and the noise shaping.

26. The method of claim 24, wherein receiving the control signaling comprises:
receiving the control signaling indicating the change in the one or more radio frequency thresholds based at least in part on at least a channel type, or a modulation order, or a modulation and coding scheme, or a resource allocation size, or a resource allocation location, or a transmission rank, or a waveform type, or a frequency band, or a combination thereof associated with the wireless signaling.

27. The method of claim 24, wherein receiving the control signaling comprises:
receiving, via the control signaling, information indicating an amount by which at least one of the one or more radio frequency thresholds is to change.

28. A method for wireless communication by a wireless communication device, comprising:
sampling a wireless communication signal in accordance with a sampling rate;
comparing a plurality of samples to a clipping threshold, wherein the plurality of samples are obtained in accordance with the sampling;
generating, based at least in part on the comparing, a set of values comprising one or more first values and one or more second values, wherein each first value of the one or more first values is associated with an error margin between a respective sample of the plurality of samples and the clipping threshold and each second value of the one or more second values comprises an inversion of a respective first value; and
applying the set of values to the plurality of samples prior to an interpolation of the wireless communication signal.

29. The method of claim 28, further comprising:
applying a scalar to the set of values, wherein applying the set of values to the plurality of samples is based at least in part on applying the scalar.

30. The method of claim 28, further comprising:
modifying the set of values by applying a parameter to each value of the set of values, wherein applying the set of values to the plurality of samples is based at least in part on modifying the set of values in accordance with the parameter.
